(19) United States
(12) Patent Application Publication
(10) Pub. No.: US 2017/0008406 A1
(43) Pub. Date: Jan. 12, 2017

(54) WIRELESS POWER TRANSFER SYSTEM AND VEHICLE POWER SUPPLY DEVICE

(71) Applicant: IHI CORPORATION, Tokyo (JP)

(72) Inventors: Yuji TAKATSU, Tokyo (JP); Susumu TOKURA, Tokyo (JP); Akio UEDA, Tokyo (JP); Sho HASHIZUME, Tokyo (JP); Kei AKUNE, Tokyo (JP); Tooru HAYASHI, Tokyo (JP)

(73) Assignee: IHI CORPORATION, Tokyo (JP)

(21) Appl. No.: 15/273,142

(22) Filed: Sep. 22, 2016

Related U.S. Application Data
(63) Continuation of application No. PCT/JP2015/059223, filed on Mar. 25, 2015.

(30) Foreign Application Priority Data
Mar. 27, 2014 (JP) 2014-064982

(51) Int. Cl. B60L 11/18; E04H 6/18; H02J 7/02; E04H 6/34; H02J 50/12; H01F 38/14

(52) U.S. Cl. CPC B60L 11/182; H02J 50/12; H01F 38/14; H02J 7/025; E04H 6/34; E04H 6/18

(57) ABSTRACT

A wireless power transfer system includes: a power receiving apparatus having a power supply secondary coil, and a power supply apparatus having a power supply primary coil, and a drive circuit that drives the power supply primary coil. The power supply primary coil and the power supply secondary coil are arranged such that a first magnetic flux direction line that is a linear virtual line extending in accordance with a direction of a magnetic flux of a magnetic field generated in a central part of the power supply primary coil and a second magnetic flux direction line that is a linear virtual line extending in accordance with a direction of a magnetic flux of a magnetic field generated in a center of the power supply secondary coil substantially intersect, and electric power is capable of being supplied to the power supply secondary coil.

### CROSS-REFERENCE TO RELATED APPLICATIONS

This application is a continuation application of International Application No. PCT/JP2015/059223, filed Mar. 25, 2015, which claims priority to Japanese Patent Application No. 2014-064982 filed Mar. 27, 2014. The contents of these applications are incorporated herein by reference in their entirety.

### TECHNICAL FIELD

The present disclosure relates to a wireless power transfer system and a vehicle power supply device that supplies electric power to a vehicle capable of receiving power supply. This application is based on and claims priority to Japanese Patent Application No. 2014-064982 filed Mar. 27, 2014, the entire contents of which are incorporated herein by reference.

### BACKGROUND ART

In recent years, vehicles driven by electric power have been used.

This leads to a need for supplying electric power to a vehicle.

For example, electric power is supplied to a parked vehicle by a power supply apparatus.

The power supply apparatus is capable of supplying electric power to a vehicle in a wireless manner.

For example, such an idea has been studied that a vehicle has a wireless type power supply secondary coil on a bottom part thereof, and a power supply primary coil is provided below the vehicle to supply electric power to the vehicle.

FIGS. 15A and 15B are conceptual diagrams of a wireless power transfer system.

The concept illustrated in FIGS. 15A and 15B has been disclosed in U.S. Pat. No. 8,035,255.

### CITATION LIST

### Patent Literature

Patent Literature 1: Japanese Unexamined Patent Publication No. 2011-60260

Patent Literature 2: Japanese Unexamined Patent Publication No. 2011-97814

Patent Literature 3: U.S. Pat. No. 8,035,255

Patent Literature 4: U.S. Pat. No. 8,106,539

### SUMMARY

### Technical Problem

The employment of a wireless type is expected to contribute to power supply from a power supply primary coil to a power supply secondary coil.

The employment of the wireless type is also expected to make a method of use easy when supplying electric power from the power supply primary coil to the power supply secondary coil.

In a wireless power transfer system, electric power is supplied in a wireless manner from the power supply primary coil to the power supply secondary coil via a magnetic circuit formed in a space between the power supply primary coil and the power supply secondary coil.

This feature imposes a reasonable restriction on a distance between the power supply primary coil and the power supply secondary coil. An attempt to supply electric power while exceeding the restriction leads to poor performance, that is, a large energy loss.

The power supply primary coil and the power supply secondary coil preferably face each other where possible.

Due to a restriction on an installation place, however, the power supply primary coil and the power supply secondary coil might not be able to face each other.

It is preferable to provide such a configuration that the power supply primary coil and the power supply secondary coil can perform the wireless power transfer even in this case.

The present disclosure describes a wireless power transfer system and a vehicle power supply device capable of performing easily available power supply using a simple structure.

### Solution to Problem

In order to achieve the above-mentioned purpose, an aspect of the present disclosure is a wireless power transfer system including: a power receiving apparatus having a power supply secondary coil that is a coil circuit capable of performing wireless power transfer, the power receiving apparatus being capable of supplying electric power to a load; and a power supply apparatus having a power supply primary coil that is a coil circuit capable of performing the wireless power transfer, and a drive circuit that drives the power supply primary coil, wherein the power supply primary coil and the power supply secondary coil are arranged such that a first magnetic flux direction line that is a linear virtual line extending in accordance with a direction of a magnetic flux of a magnetic field generated in a central part of the power supply primary coil and a second magnetic flux direction line that is a linear virtual line extending in accordance with a direction of a magnetic flux of a magnetic field generated in a center of the power supply secondary coil substantially intersect, and electric power supplied by the wireless power transfer from the power supply primary coil is capable of being supplied to the power supply secondary coil.

In this context, the words “substantially intersect” mean “intersecting while allowing some displacement”.

Owing to the above-mentioned configuration, the power receiving apparatus has the power supply secondary coil that is the coil circuit capable of performing the wireless power transfer, and the power receiving apparatus is capable of supplying electric power to the load. The power supply apparatus has the power supply primary coil that is the coil circuit capable of performing the wireless power transfer, and the drive circuit that drives the power supply primary coil. The power supply primary coil and the power supply secondary coil are arranged such that the first magnetic flux direction line that is the linear virtual line extending in accordance with the direction of the magnetic flux of the magnetic field generated in the central part of the power supply primary coil and the second magnetic flux direction line that is the linear virtual line extending in accordance with the direction of the magnetic flux of the magnetic field generated in the center of the power supply secondary coil substantially intersect. Electric power supplied by the wireless power transfer from the power supply primary coil is capable of being supplied to the power supply secondary coil.

As a result, the wireless power transfer can be performed from the power supply primary coil to the power supply secondary coil that is in a relatively inclined posture.

Hereinafter, a wireless power transfer system according to an embodiment of the present disclosure will be described. The present disclosure includes any of embodiments described below or an aspect that combines two or more of these embodiments.

The wireless power transfer system according to the embodiment of the present disclosure includes a relay apparatus having at least one relay coil that is a coil circuit, wherein the power supply primary coil, at least one of the relay coil, and the power supply secondary coil are arranged such that the first magnetic flux direction line that is the linear virtual line extending in accordance with the direction of the magnetic flux of the magnetic field generated in the central part of the power supply primary coil and the second magnetic flux direction line that is the linear virtual line extending in accordance with the direction of the magnetic flux of the magnetic field generated in the center of the power supply secondary coil substantially intersect, and electric power supplied by the wireless power transfer from the power supply primary coil is capable of being supplied to the power supply secondary coil via the relay apparatus.

Owing to the above-mentioned configuration of the embodiment, the relay apparatus has at least one of the relay coil that is the coil circuit. The power supply primary coil, at least one of the relay coil, and the power supply secondary coil are arranged such that the first magnetic flux direction line that is the linear virtual line extending in accordance with the direction of the magnetic flux of the magnetic field generated in the central part of the power supply primary coil and the second magnetic flux direction line that is the linear virtual line extending in accordance with the direction of the magnetic flux of the magnetic field generated in the center of the power supply secondary coil substantially intersect. Electric power supplied by the wireless power transfer from the power supply primary coil is capable of being supplied to the power supply secondary coil via the relay apparatus.

As a result, the wireless power transfer can be performed from the power supply primary coil to the power supply secondary coil that is physically distant from the power supply primary coil and in the relatively inclined posture.

The wireless power transfer system according to the embodiment of the present disclosure is configured such that a slope of a linear virtual line extending in accordance with a direction of a magnetic flux of a magnetic field generated in a central part of the relay coil is between a slope of the first magnetic flux direction line and a slope of the second magnetic flux direction line, and electric power supplied by the wireless power transfer from the power supply primary coil is capable of being supplied to the power supply secondary coil via the relay coil.

Owing to the above-mentioned configuration of the embodiment, the slope of the linear virtual line extending in accordance with the direction of the magnetic flux of the magnetic field generated in the central part of the relay coil is between the slope of the first magnetic flux direction line and the slope of the second magnetic flux direction line. Electric power supplied by the wireless power transfer from the power supply primary coil is capable of being supplied to the power supply secondary coil via the relay coil.

As a result, the wireless power transfer can be efficiently performed from the power supply primary coil to the power supply secondary coil that is physically distant from the power supply primary coil and in the relatively inclined posture.

The wireless power transfer system according to the embodiment of the present disclosure is configured such that the relay coil has a first coil circuit and a second coil circuit serving as an integrated coil structure, a direction of a magnetic flux of a magnetic field generated in a central part of the first coil circuit coincides with the first magnetic flux direction line, a direction of a magnetic flux of a magnetic field generated in a central part of the second coil circuit coincides with the second magnetic flux direction line, and when the wireless power transfer is performed from the power supply primary coil to the first coil circuit of the relay coil, the wireless power transfer is simultaneously capable of being performed from the second coil circuit of the relay coil to the power supply secondary coil.

Owing to the above-mentioned configuration of the embodiment, the relay coil has the first coil circuit and the second coil circuit serving as the integrated coil structure. The direction of the magnetic flux of the magnetic field generated in the central part of the first coil circuit coincides with the first magnetic flux direction line. The direction of the magnetic flux of the magnetic field generated in the central part of the second coil circuit coincides with the second magnetic flux direction line. When the wireless power transfer is performed from the power supply primary coil to the first coil circuit of the relay coil, the wireless power transfer is simultaneously capable of being performed from the second coil circuit of the relay coil to the power supply secondary coil.

As a result, the wireless power transfer can be efficiently performed from the power supply primary coil to the power supply secondary coil that is physically distant from the power supply primary coil and in the relatively inclined posture.

The wireless power transfer system according to the embodiment of the present disclosure is configured such that a relay apparatus has a first relay circuit and a second relay circuit that are the two relay circuits, and has a capacitor, the first relay circuit has a first relay coil, the second relay circuit has a second relay coil, a direction of a magnetic flux of a magnetic field generated in a central part of the first relay coil of the first relay circuit coincides with the first magnetic flux direction line, a direction of a magnetic flux of a magnetic field generated in a central part of the second relay coil of the second relay circuit coincides with the second magnetic flux direction line, and when electric power supplied by the wireless power transfer from the power supply primary coil to the first relay coil is stored in or discharged into the capacitor, electric power is simultaneously supplied by the wireless power transfer from the second relay coil to the power supply secondary coil.

Owing to the above-mentioned configuration of the embodiment, the relay apparatus has the first relay circuit and the second relay circuit that are the two relay circuits, and has the capacitor. The first relay circuit has the first relay coil. The second relay circuit has the second relay coil. The direction of the magnetic flux of the magnetic field generated in the central part of the first relay coil of the first relay circuit coincides with the first magnetic flux direction line. The direction of the magnetic flux of the magnetic field generated in the central part of the second relay coil of the second relay circuit coincides with the second magnetic flux direction line. When electric power supplied by the wireless power transfer from the power supply primary coil to the first relay coil is stored in or discharged into the capacitor, electric power is simultaneously supplied by the wireless power transfer from the second relay coil to the power supply secondary coil.

As a result, the wireless power transfer can be efficiently performed from the power supply primary coil to the power supply secondary coil that is physically distant from the power supply primary coil and in the relatively inclined posture.

The wireless power transfer system according to the embodiment of the present disclosure is configured such that the relay apparatus has an iron core that functions as a magnetic circuit, wherein the iron core is a lump surrounded by a first end surface that is an end surface orthogonal to the first magnetic flux direction line, a second end surface that is an end surface orthogonal to the second magnetic flux direction line, and a side surface, and electric power supplied by the wireless power transfer from the power supply primary coil is capable of being supplied to the power supply secondary coil via the iron core.

Owing to the above-mentioned configuration of the embodiment, the relay apparatus has the iron core that functions as the magnetic circuit. The iron core is the lump surrounded by the first end surface that is the end surface orthogonal to the first magnetic flux direction line, the second end surface that is the end surface orthogonal to the second magnetic flux direction line, and the side surface. Electric power supplied by the wireless power transfer from the power supply primary coil is capable of being supplied to the power supply secondary coil via the iron core. The wireless power transfer can be efficiently performed from the power supply primary coil to the power supply secondary coil that is physically distant from the power supply primary coil and in the relatively inclined posture.

As a result, the wireless power transfer can be efficiently performed from the power supply primary coil to the power supply secondary coil that is physically distant from the power supply primary coil and in the relatively inclined posture.

In order to achieve the above-mentioned purpose, an aspect of the present disclosure is a vehicle power supply device that supplies electric power to a vehicle, the vehicle incorporating a power supply secondary coil, the vehicle power supply device including: a main structure provided with a storage space arranged along a moving path; a power supply apparatus provided at a specific position that is at least one particular position on the moving path, the power supply apparatus having a power supply primary coil capable of performing wireless power transfer and a drive circuit that drives the power supply primary coil; a vehicle support structure that is a structure capable of supporting the vehicle; a moving carriage having a moving carriage main body and the power supply primary coil incorporated in the moving carriage main body, the moving carriage main body being capable of supporting the vehicle support structure that supports the vehicle and moving on the moving path; and a transfer apparatus capable of transferring the vehicle between the moving carriage main body and the storage space, wherein when the moving carriage stops at the specific position on the moving path, the power supply primary coil and the power supply secondary coil are arranged such that a first magnetic flux direction line that is a linear virtual line extending in accordance with a direction of a magnetic flux of a magnetic field generated in a central part of the power supply primary coil and a second magnetic flux direction line that is a linear virtual line extending in accordance with a direction of a magnetic flux of a magnetic field generated in a center of the power supply secondary coil substantially intersect, and the wireless power transfer is performed from the power supply primary coil to the power supply secondary coil incorporated in the vehicle supported by the vehicle support structure supported by the moving carriage.

Owing to the above-mentioned configuration, the power supply secondary coil is incorporated in the vehicle. The main structure is provided with the storage space arranged along the moving path. The power supply apparatus is provided at the specific position that is at least one particular position on the moving path, and the power supply apparatus has the power supply primary coil capable of performing the wireless power transfer and the drive circuit that drives the power supply primary coil. The vehicle support structure is the structure capable of supporting the vehicle. The moving carriage has the moving carriage main body and the power supply primary coil incorporated in the moving carriage main body, and the moving carriage main body is capable of supporting the vehicle support structure that supports the vehicle and moving on the moving path. The transfer apparatus is capable of transferring the vehicle between the moving carriage main body and the storage space. When the moving carriage stops at the specific position on the moving path, the power supply primary coil and the power supply secondary coil are arranged such that the first magnetic flux direction line that is the linear virtual line extending in accordance with the direction of the magnetic flux of the magnetic field generated in the central part of the power supply primary coil and the second magnetic flux direction line that is the linear virtual line extending in accordance with the direction of the magnetic flux of the magnetic field generated in the center of the power supply secondary coil substantially intersect. The wireless power transfer is performed from the power supply primary coil to the power supply secondary coil incorporated in the vehicle supported by the vehicle support structure supported by the moving carriage.

As a result, electric power can be supplied to the vehicle supported by the vehicle support structure supported by the moving carriage that moves along the moving path.

In order to achieve the above-mentioned purpose, an aspect of the present disclosure is a vehicle power supply device that supplies electric power to a vehicle, the vehicle power supply device including: a main structure provided with a storage space arranged along a moving path; a power supply apparatus provided at a specific position that is at least one particular position on the moving path, the power supply apparatus having a power supply primary coil capable of performing wireless power transfer and a drive circuit that drives the power supply primary coil; a vehicle support structure having a vehicle support structure main body and a power supply secondary coil, the vehicle support structure main body being capable of holding a wheel of the vehicle to support the vehicle, the power supply secondary coil being provided at the vehicle support structure main body and capable of receiving the wireless power transfer; a moving carriage having a moving carriage main body and the power supply primary coil incorporated in the moving carriage main body, the moving carriage main body being capable of supporting the vehicle support structure that supports the vehicle and moving on the moving path; and a transfer apparatus capable of transferring the vehicle between the moving carriage main body and the storage space, wherein when the moving carriage stops at the specific position on the moving path, the power supply primary coil and the power supply secondary coil are arranged such that a first magnetic flux direction line that is a linear virtual line extending in accordance with a direction of a magnetic flux of a magnetic field generated in a central part of the power supply primary coil and a second magnetic flux direction line that is a linear virtual line extending in accordance with a direction of a magnetic flux of a magnetic field generated in a center of the power supply secondary coil substantially intersect, the wireless power transfer is performed from the power supply primary coil to the power supply secondary coil of the vehicle support structure supported by the moving carriage, and electric power supplied by the wireless power transfer to the power supply secondary coil is supplied to the vehicle supported by the vehicle support structure.

Owing to the above-mentioned configuration, the main structure is provided with the storage space arranged along the moving path. The power supply apparatus is provided at the specific position that is at least one particular position on the moving path, and the power supply apparatus has the power supply primary coil capable of performing the wireless power transfer and the drive circuit that drives the power supply primary coil. The vehicle support structure has the vehicle support structure main body and the power supply secondary coil, the vehicle support structure main body is capable of holding the wheel of the vehicle to support the vehicle, and the power supply secondary coil is provided at the vehicle support structure main body and capable of receiving the wireless power transfer. The moving carriage has the moving carriage main body and the power supply primary coil incorporated in the moving carriage main body, and the moving carriage main body is capable of supporting the vehicle support structure that supports the vehicle and moving on the moving path. The transfer apparatus is capable of transferring the vehicle between the moving carriage main body and the storage space. When the moving carriage stops at the specific position on the moving path, the power supply primary coil and the power supply secondary coil are arranged such that the first magnetic flux direction line that is the linear virtual line extending in accordance with the direction of the magnetic flux of the magnetic field generated in the central part of the power supply primary coil and the second magnetic flux direction line that is the linear virtual line extending in accordance with the direction of the magnetic flux of the magnetic field generated in the center of the power supply secondary coil substantially intersect. The wireless power transfer is performed from the power supply primary coil to the power supply secondary coil of the vehicle support structure supported by the moving carriage, and electric power supplied by the wireless power transfer to the power supply secondary coil is supplied to the vehicle supported by the vehicle support structure.

As a result, electric power can be supplied to the vehicle supported by the vehicle support structure supported by the moving carriage that moves along the moving path.

Hereinafter, a vehicle power supply device according to an embodiment of the present disclosure will be described. The present disclosure includes any of embodiments described below or an aspect that combines two or more of these embodiments.

The vehicle power supply device according to the embodiment of the present disclosure includes a relay apparatus incorporated in the moving carriage main body and having a relay coil that is a coil circuit, wherein when the moving carriage stops at the specific position on the moving path, the power supply primary coil, at least one of the relay coil, and the power supply secondary coil are arranged such that the first magnetic flux direction line that is the linear virtual line extending in accordance with the direction of the magnetic flux of the magnetic field generated in the central part of the power supply primary coil and the second magnetic flux direction line that is the linear virtual line extending in accordance with the direction of the magnetic flux of the magnetic field generated in the center of the power supply secondary coil substantially intersect, and electric power supplied by the wireless power transfer from the power supply primary coil is capable of being supplied to the power supply secondary coil via the relay apparatus.

Owing to the above-mentioned configuration of the embodiment, the relay apparatus is incorporated in the moving carriage main body and has the relay coil that is the coil circuit. When the moving carriage stops at the specific position on the moving path, the power supply primary coil, at least one of the relay coil, and the power supply secondary coil are arranged such that the first magnetic flux direction line that is the linear virtual line extending in accordance with the direction of the magnetic flux of the magnetic field generated in the central part of the power supply primary coil and the second magnetic flux direction line that is the linear virtual line extending in accordance with the direction of the magnetic flux of the magnetic field generated in the center of the power supply secondary coil substantially intersect. Electric power supplied by the wireless power transfer from the power supply primary coil is capable of being supplied to the power supply secondary coil via the relay apparatus.

As a result, electric power can be supplied to the vehicle supported by the vehicle support structure supported by the moving carriage that moves along the moving path.

The vehicle power supply device according to the embodiment of the present disclosure includes a relay apparatus incorporated in the moving carriage main body and having an iron core that functions as a magnetic circuit, wherein when the moving carriage stops at the specific position on the moving path, the iron core is a lump surrounded by a first end surface that is an end surface orthogonal to the first magnetic flux direction line, a second end surface that is an end surface orthogonal to the second magnetic flux direction line, and a side surface, and the power supply primary coil, at least one of the iron core, and the power supply secondary coil are arranged such that the first magnetic flux direction line that is the linear virtual line extending in accordance with the direction of the magnetic flux of the magnetic field generated in the central part of the power supply primary coil and the second magnetic flux direction line that is the linear virtual line extending in accordance with the direction of the magnetic flux of the magnetic field generated in the center of the power supply secondary coil substantially intersect, and electric power supplied by the wireless power transfer from the power supply primary coil is capable of being supplied to the power supply secondary coil via the relay apparatus.

Owing to the above-mentioned configuration of the embodiment, the relay apparatus is incorporated in the moving carriage main body and has the iron core that functions as the magnetic circuit.

When the moving carriage stops at the specific position on the moving path, the iron core is the lump surrounded by the first end surface that is the end surface orthogonal to the first magnetic flux direction line, the second end surface that is the end surface orthogonal to the second magnetic flux direction line, and the side surface, and the power supply primary coil, at least one of the iron core, and the power supply secondary coil are arranged such that the first magnetic flux direction line that is the linear virtual line extending in accordance with the direction of the magnetic flux of the magnetic field generated in the central part of the power supply primary coil and the second magnetic flux direction line that is the linear virtual line extending in accordance with the direction of the magnetic flux of the magnetic field generated in the center of the power supply secondary coil substantially intersect. Electric power supplied by the wireless power transfer from the power supply primary coil is capable of being supplied to the power supply secondary coil via the relay apparatus.

As a result, electric power can be supplied to the vehicle supported by the vehicle support structure supported by the moving carriage that moves along the moving path.

### Effects of Disclosure

As described above, the wireless power transfer system according to an aspect of the present disclosure has the following effects owing to its configuration.

As the power supply primary coil driven by the drive circuit and the power supply secondary coil that supplies electric power to the load are arranged in this order in series along a bending virtual route such that the directions of the magnetic fluxes of the magnetic fields generated in the respective central parts substantially intersect, when electric power supplied by the wireless power transfer from the power supply primary coil is supplied to the power supply secondary coil, the wireless power transfer can be performed from the power supply primary coil to the power supply secondary coil that is in the relatively inclined posture.

As the power supply primary coil driven by the drive circuit, the electrically independent relay coil, and the power supply secondary coil that supplies electric power to the load are arranged in this order in series along a bending virtual route such that the directions of the magnetic fluxes of the magnetic fields generated in the respective central parts intersect, when electric power supplied by the wireless power transfer from the power supply primary coil is supplied to the power supply secondary coil via the relay coil, the wireless power transfer can be performed from the power supply primary coil to the power supply secondary coil that is physically distant from the power supply primary coil and in the relatively inclined posture.

As the slope of the linear virtual line extending in accordance with the direction of the magnetic flux of the magnetic field generated in the central part of the relay coil is between the slope of the first magnetic flux direction line and the slope of the second magnetic flux direction line, when electric power supplied by the wireless power transfer from the power supply primary coil is supplied to the power supply secondary coil via the relay coil, the wireless power transfer can be efficiently performed from the power supply primary coil to the power supply secondary coil that is physically distant from the power supply primary coil and in the relatively inclined posture.

The first coil circuit and the second coil circuit serving as the integrated coil structure are used, the magnetic flux direction in the central part of the first coil circuit is made to coincide with the first magnetic flux direction line, and the magnetic flux direction in the central part of the second coil circuit is made to coincide with the second magnetic flux direction line. When the wireless power transfer is performed from the power supply primary coil to the first coil circuit, the wireless power transfer is simultaneously performed from the second coil circuit to the power supply secondary coil. Therefore, the wireless power transfer can be efficiently performed from the power supply primary coil to the power supply secondary coil that is physically distant from the power supply primary coil and in the relatively inclined posture.

The first relay circuit, the second relay circuit, and the capacitor are used, the magnetic flux direction in the central part of the first relay coil is made to coincide with the first magnetic flux direction line, and the magnetic flux direction in the central part of the second relay coil is made to coincide with the second magnetic flux direction line. When the wireless power transfer is performed from the power supply primary coil to the first relay coil to charge the capacitor, the wireless power transfer is simultaneously performed from the second relay coil to the power supply secondary coil. Therefore, the wireless power transfer can be efficiently performed from the power supply primary coil to the power supply secondary coil that is physically distant from the power supply primary coil and in the relatively inclined posture.

The wireless power transfer is performed from the power supply primary coil to the power supply secondary coil via the iron core that is the lump surrounded by the first end surface that is the end surface orthogonal to the first magnetic flux direction line, the second end surface that is the end surface orthogonal to the second magnetic flux direction line, and the side surface. Therefore, the wireless power transfer can be efficiently performed from the power supply primary coil to the power supply secondary coil that is physically distant from the power supply primary coil and in the relatively inclined posture.

As described above, the vehicle power supply device according to an aspect of the present disclosure has the following effects owing to its configuration.

The power supply primary coil driven by the drive circuit is provided at the specific position on the moving path. When the moving carriage that supports the vehicle support structure that supports the vehicle is stopped at the specific position, electric power supplied by the wireless power transfer from the power supply primary coil is supplied to the vehicle supported by the vehicle support structure supported by the moving carriage. Therefore, electric power can be supplied to the vehicle supported by the vehicle support structure supported by the moving carriage that moves along the moving path.

The power supply primary coil driven by the drive circuit is provided at the specific position on the moving path. When the moving carriage that supports the vehicle support structure that supports the vehicle is stopped at the specific position, electric power supplied by the wireless power transfer from the power supply primary coil is supplied to the power supply secondary coil provided at the vehicle support structure supported by the moving carriage, and the supplied electric power is supplied to the vehicle supported by the vehicle support structure. Therefore, electric power can be supplied to the vehicle supported by the vehicle support structure supported by the moving carriage that moves along the moving path.

The power supply primary coil driven by the drive circuit is provided at the specific position on the moving path, and the electrically independent relay coil is provided at the moving carriage. When the moving carriage that supports the vehicle support structure that supports the vehicle is stopped at the specific position, electric power supplied by the wireless power transfer from the power supply primary coil is supplied by the wireless power transfer via the relay coil, and supplied to the vehicle supported by the moving carriage. Therefore, electric power can be supplied to the vehicle supported by the vehicle support structure supported by the moving carriage that moves along the moving path.

The power supply primary coil driven by the drive circuit is provided at the specific position on the moving path, and the iron core that functions as the magnetic circuit is provided at the moving carriage. When the moving carriage that supports the vehicle support structure that supports the vehicle is stopped at the specific position, electric power supplied by the wireless power transfer from the power supply primary coil is supplied by the wireless power transfer via the iron core, and supplied to the vehicle supported by the moving carriage. Therefore, electric power can be supplied to the vehicle supported by the vehicle support structure supported by the moving carriage that moves along the moving path.

Thus, it is possible to provide the wireless power transfer system and the vehicle power supply device that are easily available using a simple structure, and a parking device to which the wireless power transfer system and the vehicle power supply device are applied.

### BRIEF DESCRIPTION OF DRAWINGS

FIG. 1 is a perspective diagram of a wireless power transfer system according to a first embodiment of the present disclosure.

FIG. 2 is a perspective diagram of a wireless power transfer system according to a second embodiment of the present disclosure.

FIG. 3 is a perspective diagram of a wireless power transfer system according to a third embodiment of the present disclosure.

FIG. 4 is a perspective diagram of a wireless power transfer system according to a fourth embodiment of the present disclosure.

FIG. 5 is a perspective diagram of a wireless power transfer system according to a fifth embodiment of the present disclosure.

FIG. 6 is a perspective diagram of a wireless power transfer system according to a sixth embodiment of the present disclosure.

FIG. 7 is a plan view of a parking device to which a vehicle power supply device according to the first embodiment of the present disclosure is applied.

FIG. 8 is a side view of the parking device to which the vehicle power supply device according to the first embodiment of the present disclosure is applied.

FIG. 9 is a side cross-sectional view of the vehicle power supply device according to the first embodiment of the present disclosure.

FIG. 10 is a side cross-sectional view of a vehicle power supply device according to the second embodiment of the present disclosure.

FIG. 11 is a plan view of a vehicle power supply device according to the third embodiment of the present disclosure.

FIG. 12 is a front view of a vehicle power supply device according to the fourth embodiment of the present disclosure.

FIG. 13 is a perspective view of the vehicle power supply device according to the fourth embodiment of the present disclosure.

FIG. 14 is a front view of a vehicle power supply device according to the fifth embodiment of the present disclosure.

FIGS. 15A and 15B are conceptual diagrams of the wireless power transfer system.

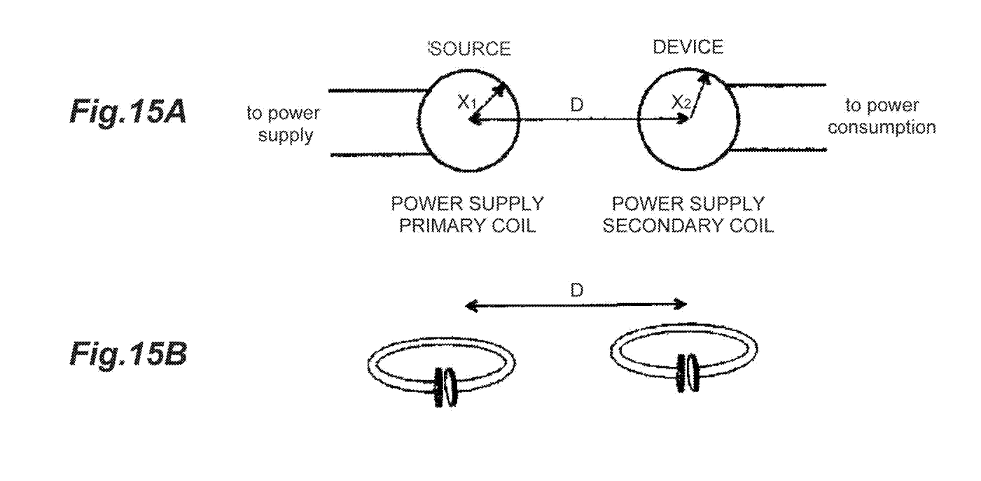

### DESCRIPTION OF EMBODIMENTS

Hereinafter, embodiments for practicing the present disclosure will be described with reference to the drawings.

To begin with, a wireless power transfer system according to an embodiment of the present disclosure will be described based on the drawings.

First, a wireless power transfer system 100 according to a first embodiment of the present disclosure will be described based on the drawings.

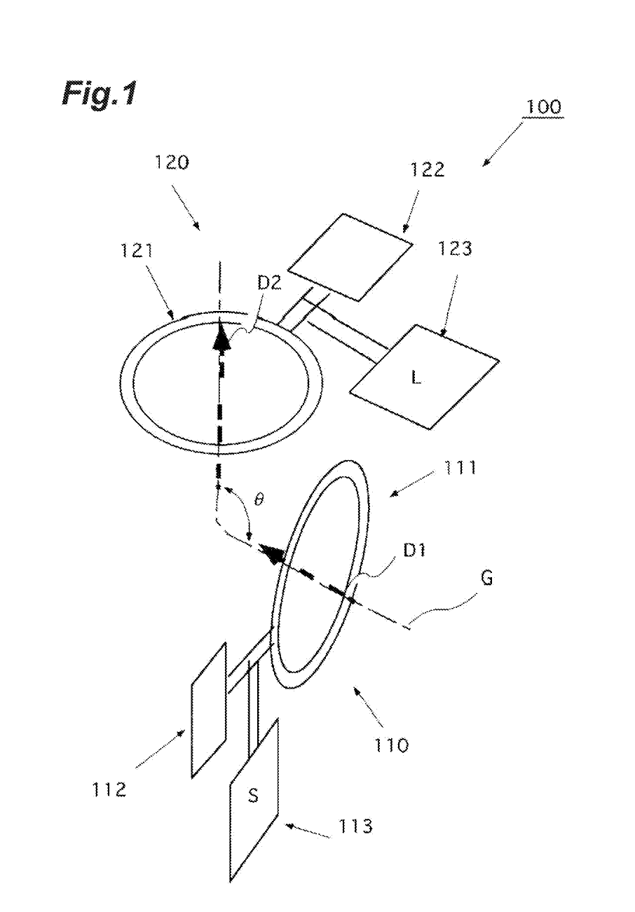

FIG. 1 is a perspective diagram of the wireless power transfer system according to the first embodiment of the present disclosure.

The wireless power transfer system 100 according to the first embodiment of the present disclosure includes a power supply apparatus 110 and a power receiving apparatus 120.

The power supply apparatus 110 includes a power supply primary coil 111, a drive circuit 113, and an adjustment circuit 112.

The power supply primary coil 111 is a transmission side coil circuit for enabling wireless power transfer.

The drive circuit 113 is an electric circuit that drives the power supply primary coil 111.

For example, the drive circuit 113 supplies AC electric power having a predetermined frequency of the power supply primary coil.

The adjustment circuit 112 is a circuit that adjusts electric and magnetic properties of the power supply apparatus 110.

For example, the adjustment circuit 112 adjusts an electromagnetic resonance frequency of the power supply apparatus 110.

The power receiving apparatus 120 is a circuit including a power supply secondary coil 121 and capable of supplying electric power to a load 123.

The power receiving apparatus 120 may include the power supply secondary coil 121 and an adjustment circuit 122.

The power supply secondary coil 121 is a reception side coil circuit for enabling the wireless power transfer.

The adjustment circuit 122 is a circuit that adjusts electric and magnetic properties of the power receiving apparatus 120.

For example, the adjustment circuit 122 adjusts an electromagnetic resonance frequency of the power receiving apparatus 120.

The power supply primary coil 111 and the power supply secondary coil 121 are arranged such that a first magnetic flux direction line D1 that is a linear virtual line extending in accordance with a direction of a magnetic flux of a magnetic field generated in a central part of the power supply primary coil 111 and a second magnetic flux direction line D2 that is a linear virtual line extending in accordance with a direction of a magnetic flux of a magnetic field generated in a center of the power supply secondary coil 121 substantially intersect.

For example, the power supply primary coil 111 and the power supply secondary coil 121 are arranged in this order in series along a bending virtual route G such that the first magnetic flux direction line D1 that is the linear virtual line extending in accordance with the direction of the magnetic flux of the magnetic field generated in the central part of the power supply primary coil 111 and the second magnetic flux direction line D2 that is the linear virtual line extending in accordance with the direction of the magnetic flux of the magnetic field generated in the center of the power supply secondary coil 121 substantially intersect.

In other words, the power supply primary coil 111 and the power supply secondary coil 121 are arranged in the order of the power supply primary coil 111 and the power supply secondary coil 121 in series along the bending virtual route G. In FIG. 1, it is illustrated that the power supply primary coil 111 and the power supply secondary coil 121 are arranged in this order in series along the bending virtual route such that the first magnetic flux direction line D1 that is the linear virtual line extending in accordance with the direction of the magnetic flux of the magnetic field generated in the central part of the power supply primary coil 111 and the second magnetic flux direction line D2 that is the linear virtual line extending in accordance with the direction of the magnetic flux of the magnetic field generated in the center of the power supply secondary coil 121 substantially intersect at an intersecting angle θ.

For example, the power supply primary coil 111 and the power supply secondary coil 121 are arranged in this order in series along the bending virtual route such that the first magnetic flux direction line D1 that is the linear virtual line extending in accordance with the direction of the magnetic flux of the magnetic field generated in the central part of the power supply primary coil 111 and the second magnetic flux direction line D2 that is the linear virtual line extending in accordance with the direction of the magnetic flux of the magnetic field generated in the center of the power supply secondary coil 121 are substantially orthogonal to each other.

For example, the power supply primary coil 111 and the power supply secondary coil 121 are arranged in this order in series along the bending virtual route such that a first virtual central axis that is a virtual central axis around which a coil of the power supply primary coil 111 is wound and a second virtual central axis that is a virtual central axis around which a coil of the power supply secondary coil 121 is wound substantially intersect.

For example, the power supply primary coil 111 and the power supply secondary coil 121 are arranged in this order in series along the bending virtual route such that the first virtual central axis that is the virtual central axis around which the coil of the power supply primary coil 111 is wound and the second virtual central axis that is the virtual central axis around which the coil of the power supply secondary coil 121 is wound are substantially orthogonal to each other.

For example, the power supply primary coil 111 and the power supply secondary coil 121 are arranged in this order in series along the bending virtual route such that a first virtual surface that is a planar virtual surface including, within the surface, at least a roll of coil of the coil of the power supply primary coil 111 and a second virtual surface that is a planar virtual surface including, within the surface, at least a roll of coil of the coil of the power supply secondary coil 121 substantially intersect.

For example, the power supply primary coil 111 and the power supply secondary coil 121 are arranged in this order in series along the bending virtual route such that the first virtual surface that is the planar virtual surface including, within the surface, at least a roll of coil of the coil of the power supply primary coil 111 and the second virtual surface that is the planar virtual surface including, within the surface, at least a roll of coil of the coil of the power supply secondary coil 121 are substantially orthogonal to each other.

Electric power supplied by the wireless power transfer from the power supply primary coil 111 is capable of being supplied to the power supply secondary coil 121.

When an electric current flows in the power supply primary coil 111, a magnetic field is generated in a space sandwiched between the power supply primary coil 111 and the power supply secondary coil 121, and the generated magnetic field causes an electric current of the power supply primary coil 111 to flow.

Next, a wireless power transfer system 100 according to a second embodiment of the present disclosure will be described based on the drawings.

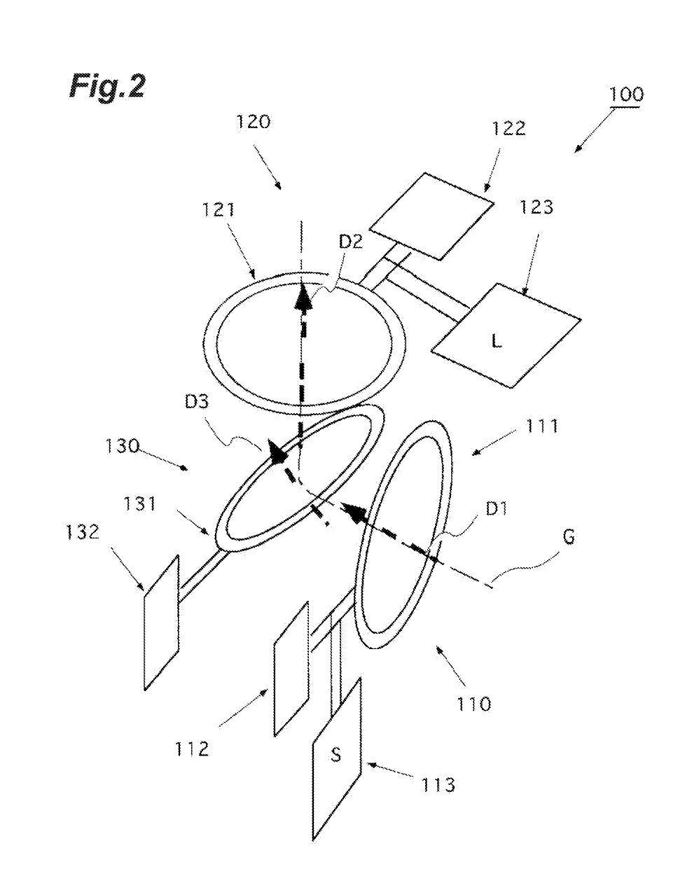

FIG. 2 is a perspective diagram of the wireless power transfer system according to the second embodiment of the present disclosure.

The wireless power transfer system 100 according to the second embodiment of the present disclosure includes a power supply apparatus 110, a power receiving apparatus 120, and a relay apparatus 130.

Since the configurations of the power supply apparatus 110 and the power receiving apparatus 120 are the same as those of the wireless power transfer system 100 according to the first embodiment, the description will be omitted.

The relay apparatus 130 is an apparatus that relays wireless power transfer from the power supply apparatus 110 to the power receiving apparatus 120.

The relay apparatus 130 includes at least one relay coil 131.

The relay apparatus 130 may include at least one relay coil 131 and an adjustment circuit 132.

The relay coil 131 is a coil circuit that is electrically independent of the power supply primary coil 111 and the power supply secondary coil 121.

For example, the relay coil 131 is a coil circuit including an electric circuit that is not electrically connected to the power supply primary coil and the power supply secondary coil.

The adjustment circuit 132 is a circuit that adjusts electric and magnetic properties of the relay apparatus 130.

For example, the adjustment circuit 132 adjusts an electromagnetic resonance frequency of the relay apparatus 130.

The power supply primary coil 111, at least one relay coil 131, and the power supply secondary coil 121 are arranged.

For example, the power supply primary coil 111, at least one relay coil 131, and the power supply secondary coil 121 are arranged in this order in series along a bending virtual route G.

In other words, the power supply primary coil 111, at least one relay coil 131, and the power supply secondary coil 121 are arranged in the order of the power supply primary coil 111, at least one relay coil 131, and the power supply secondary coil 121 in series along the bending virtual route G.

For example, the power supply primary coil 111, at least one relay coil 131, and the power supply secondary coil 121 are arranged in this order in series along the bending virtual route G such that a first magnetic flux direction line D1 that is a linear virtual line extending in accordance with a direction of a magnetic flux of a magnetic field generated in a central part of the power supply primary coil 111 and a second magnetic flux direction line D2 that is a linear virtual line extending in accordance with a direction of a magnetic flux of a magnetic field generated in a center of the power supply secondary coil 121 substantially intersect.

For example, the power supply primary coil 111, at least one relay coil 131, and the power supply secondary coil 121 are arranged in this order in series along the bending virtual route G such that the first magnetic flux direction line D1 that is the linear virtual line extending in accordance with the direction of the magnetic flux of the magnetic field generated in the central part of the power supply primary coil 111 and the second magnetic flux direction line D2 that is the linear virtual line extending in accordance with the direction of the magnetic flux of the magnetic field generated in the center of the power supply secondary coil 121 substantially intersect at an intersecting angle θ.

For example, the power supply primary coil 111, at least one relay coil 131, and the power supply secondary coil 121 are arranged in this order in series along the bending virtual route G such that the first magnetic flux direction line D1 that is the linear virtual line extending in accordance with the direction of the magnetic flux of the magnetic field generated in the central part of the power supply primary coil 111 and the second magnetic flux direction line D2 that is the linear virtual line extending in accordance with the direction of the magnetic flux of the magnetic field generated in the center of the power supply secondary coil 121 are substantially orthogonal to each other.

For example, the power supply primary coil 111, at least one relay coil 131, and the power supply secondary coil 121 are arranged in this order in series along the bending virtual route G such that a first virtual central axis that is a virtual central axis around which a coil of the power supply primary coil 111 is wound and a second virtual central axis that is a virtual central axis around which a coil of the power supply secondary coil 121 is wound substantially intersect.

For example, the power supply primary coil 111, at least one relay coil 131, and the power supply secondary coil 121 are arranged in this order in series along the bending virtual route G such that the first virtual central axis that is the virtual central axis around which the coil of the power supply primary coil 111 is wound and the second virtual central axis that is the virtual central axis around which the coil of the power supply secondary coil 121 is wound substantially intersect at an intersecting angle θ.

For example, the power supply primary coil 111, at least one relay coil 131, and the power supply secondary coil 121 are arranged in this order in series along the bending virtual route G such that the first virtual central axis that is the virtual central axis around which the coil of the power supply primary coil 111 is wound and the second virtual central axis that is the virtual central axis around which the coil of the power supply secondary coil 121 is wound are substantially orthogonal to each other.

For example, the power supply primary coil 111, at least one relay coil 131, and the power supply secondary coil 121 are arranged in this order in series along the bending virtual route G such that a first virtual surface that is a planar virtual surface including, within the surface, at least a roll of coil of the coil of the power supply primary coil 111 and a second virtual surface that is a planar virtual surface including, within the surface, at least a roll of coil of the coil of the power supply secondary coil 121 substantially intersect.

For example, the power supply primary coil 111, at least one relay coil 131, and the power supply secondary coil 121 are arranged in this order in series along the bending virtual route G such that the first virtual surface that is the planar virtual surface including, within the surface, at least a roll of coil of the coil of the power supply primary coil 111 and the second virtual surface that is the planar virtual surface including, within the surface, at least a roll of coil of the coil of the power supply secondary coil 121 substantially intersect at an intersecting angle θ.

For example, the power supply primary coil 111, at least one relay coil 131, and the power supply secondary coil 121 are arranged in this order in series along the bending virtual route G such that the first virtual surface that is the planar virtual surface including, within the surface, at least a roll of coil of the coil of the power supply primary coil 111 and the second virtual surface that is the planar virtual surface including, within the surface, at least a roll of coil of the coil of the power supply secondary coil 121 are substantially orthogonal to each other.

Electric power supplied by the wireless power transfer from the power supply primary coil 111 is capable of being supplied to the power supply secondary coil 121 via the relay apparatus 130.

For example, a slope of a linear virtual line extending in accordance with a direction of a magnetic flux of a magnetic field generated in a central part of the relay coil 131 is between a slope of the first magnetic flux direction line D1 and a slope of the second magnetic flux direction line D2, and electric power supplied by the wireless power transfer from the power supply primary coil 111 is capable of being supplied to the power supply secondary coil 121 via the relay coil 131.

For example, a slope of a virtual central axis around which a coil of the relay coil 131 is wound is between a slope of the first virtual central axis and a slope of the second virtual central axis, and electric power supplied by the wireless power transfer from the power supply primary coil 111 is capable of being supplied to the power supply secondary coil 121 via the relay coil.

For example, a slope of a virtual surface on which the coil of the relay coil 131 is wound is between a slope of the first virtual surface and a slope of the second virtual surface, and electric power supplied by the wireless power transfer from the power supply primary coil 111 is capable of being supplied to the power supply secondary coil 121 via the relay coil 131.

Next, a wireless power transfer system 100 according to a third embodiment of the present disclosure will be described based on the drawings.

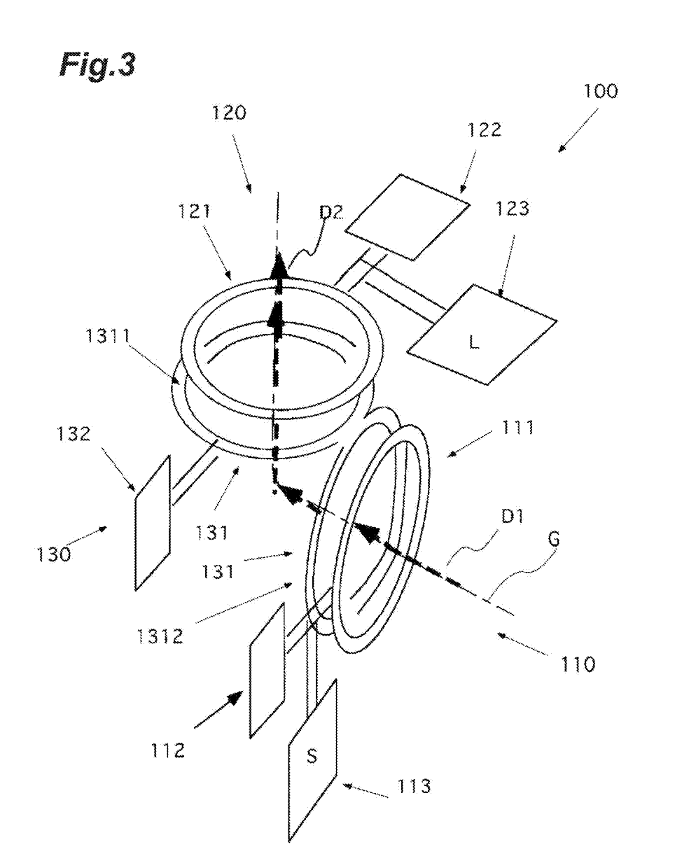

FIG. 3 is a perspective diagram of the wireless power transfer system according to the third embodiment of the present disclosure.

The wireless power transfer system 100 according to the third embodiment of the present disclosure includes a power supply apparatus 110, a power receiving apparatus 120, and a relay apparatus 130.

Since the configurations of the power supply apparatus 110 and the power receiving apparatus 120 are the same as those of the wireless power transfer system 100 according to the first embodiment, the description will be omitted.

The relay apparatus 130 is an apparatus that relays wireless power transfer from the power supply apparatus 110 to the power receiving apparatus 120.

The relay apparatus 130 includes at least one relay coil 131.

The relay apparatus 130 may include at least one relay coil 131 and an adjustment circuit 132.

The relay coil 131 is a coil circuit that is electrically independent of the power supply primary coil 111 and the power supply secondary coil 121.

For example, the relay coil 131 is a coil circuit including an electric circuit that is not electrically connected to the power supply primary coil and the power supply secondary coil.

The adjustment circuit 132 is a circuit that adjusts electric and magnetic properties of the relay apparatus 130.

For example, the adjustment circuit 132 adjusts an electromagnetic resonance frequency of the relay apparatus 130.

The relay coil 131 has a first coil circuit 1311 and a second coil circuit 1312 serving as an integrated coil structure.

For example, the relay coil 131 has the first coil circuit 1311 and the second coil circuit 1312 serving as the integrated coil structure including a unicursal electric circuit.

For example, a direction of a magnetic flux of a magnetic field generated in a central part of the first coil circuit 1311 coincides with a first magnetic flux direction line D1, and a direction of a magnetic flux of a magnetic field generated in a central part of the second coil circuit 1312 coincides with a second magnetic flux direction line D2.

For example, a virtual central axis around which a coil of the first coil circuit is wound coincides with a first virtual central axis, and a virtual central axis around which a coil of the second coil circuit is wound coincides with a second virtual central axis.

For example, a virtual surface on which the coil of the first coil circuit is wound faces a first virtual surface, and a virtual surface on which a coil of the second coil circuit is wound coincides with a second virtual surface.

When the wireless power transfer is performed from the power supply primary coil 111 to the first coil circuit 1311 of the relay coil 131, the wireless power transfer is simultaneously capable of being performed from the second coil circuit 1312 of the relay coil 131 to the power supply secondary coil 121.

Next, a wireless power transfer system according to a fourth embodiment of the present disclosure will be described based on the drawings.

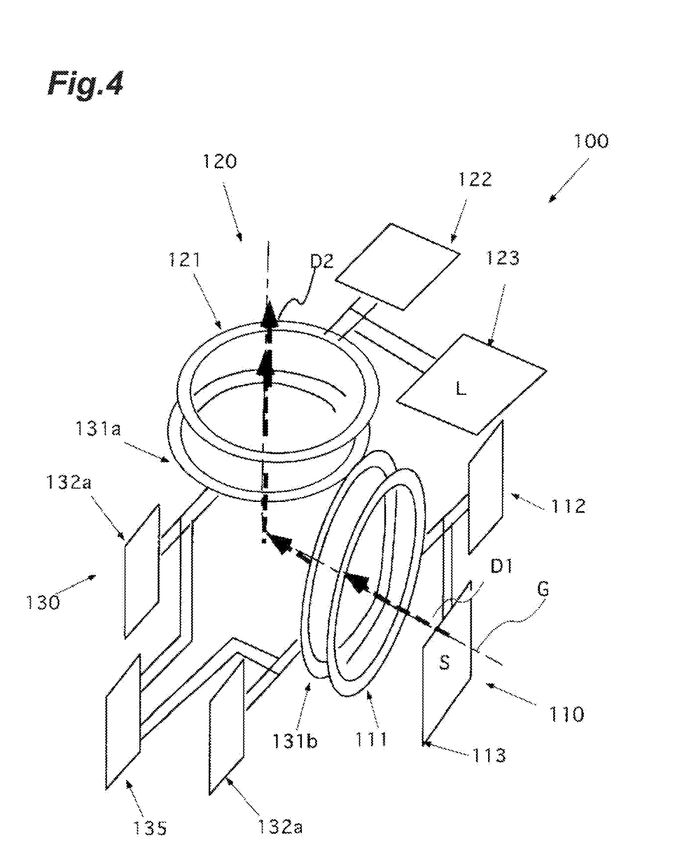

FIG. 4 is a perspective diagram of the wireless power transfer system according to the fourth embodiment of the present disclosure.

The wireless power transfer system 100 according to the fourth embodiment of the present disclosure includes a power supply apparatus 110, a power receiving apparatus 120, and a relay apparatus 130.

Since the configurations of the power supply apparatus 110 and the power receiving apparatus 120 are the same as those of the wireless power transfer system 100 according to the first embodiment, the description will be omitted.

The relay apparatus 130 is an apparatus that relays wireless power transfer from the power supply apparatus 110 to the power receiving apparatus 120.

The relay apparatus 130 includes a first relay coil 131a and a second relay coil 131b that are at least two relay coils.

The relay apparatus 130 may include the first relay coil 131a, the second relay coil 131b, and a capacitor 135.

The relay apparatus 130 may include the first relay coil 131a, the second relay coil 131b, the capacitor 135, and a first adjustment circuit 132a and a second adjustment circuit 132b that are at least two adjustment circuits.

The relay coil 131 is a coil circuit that is electrically independent of the power supply primary coil 111 and the power supply secondary coil 121.

For example, the relay coil 131 is a coil circuit including an electric circuit that is not electrically connected to the power supply primary coil and the power supply secondary coil.

The adjustment circuit 132 is a circuit that adjusts electric and magnetic properties of the relay apparatus 130.

For example, the adjustment circuit 132 adjusts an electromagnetic resonance frequency of the relay apparatus 130.

The capacitor 135 is an electric apparatus capable of charging or discharging electric power.

A direction of a magnetic flux of a magnetic field generated in a central part of the first relay coil 131a coincides with a first magnetic flux direction line D1, and a direction of a magnetic flux of a magnetic field generated in a central part of the second relay coil 131b coincides with a second magnetic flux direction line D2.

For example, a virtual central axis around which the first relay coil 131a is wound coincides with a first virtual central axis, and a virtual central axis around which the second relay coil 131b is wound coincides with a second virtual central axis.

For example, a virtual surface on which the first relay coil 131a is wound faces a first virtual surface, and a virtual surface on which the second relay coil 131b is wound coincides with a second virtual surface.

When electric power supplied by the wireless power transfer from the power supply primary coil 111 to the first relay coil 131a is stored in or discharged into the capacitor 135, electric power is simultaneously supplied by the wireless power transfer from the second relay coil 131b to the power supply secondary coil 121.

Next, a wireless power transfer system according to a fifth embodiment of the present disclosure will be described based on the drawings.

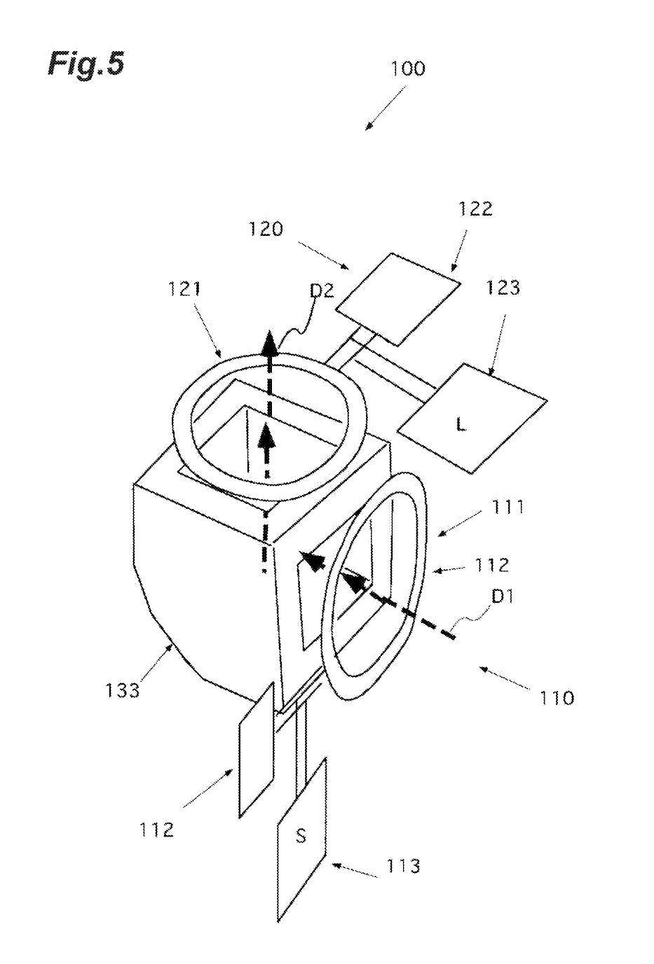

FIG. 5 is a perspective diagram of the wireless power transfer system according to the fifth embodiment of the present disclosure.

The wireless power transfer system 100 according to the fifth embodiment of the present disclosure includes a power supply apparatus 110, a power receiving apparatus 120, and a relay apparatus 130.

Since the configurations of the power supply apparatus 110 and the power receiving apparatus 120 are the same as those of the wireless power transfer system 100 according to the first embodiment, the description will be omitted.

The relay apparatus 130 is an apparatus that relays wireless power transfer from the power supply apparatus 110 to the power receiving apparatus 120.

The relay apparatus 130 includes at least one iron core 133.

The iron core 133 is an electric element that functions as a magnetic circuit.

The iron core 133 is an electric element that functions as a magnetic circuit that suppresses generation of an eddy current.

The iron core 133 may be such a lump that a plurality of thin plates are laminated in a direction orthogonal to a direction of a magnetic flux of a magnetic field.

The iron core 133 may be a lump made of ferrite.

The iron core 133 may be a lump surrounded by a first end surface that is an end surface orthogonal to a first magnetic flux direction line, a second end surface that is an end surface orthogonal to a second magnetic flux direction line, and a side surface.

For example, the iron core may be a lump surrounded by the first end surface that is an end surface orthogonal to a first virtual central axis, the second end surface that is an end surface orthogonal to a second virtual central axis, and the side surface.

Electric power supplied by the wireless power transfer from the power supply primary coil is capable of being supplied to the power supply secondary coil via the iron core.

Next, a wireless power transfer system according to a sixth embodiment of the present disclosure will be described based on the drawings.

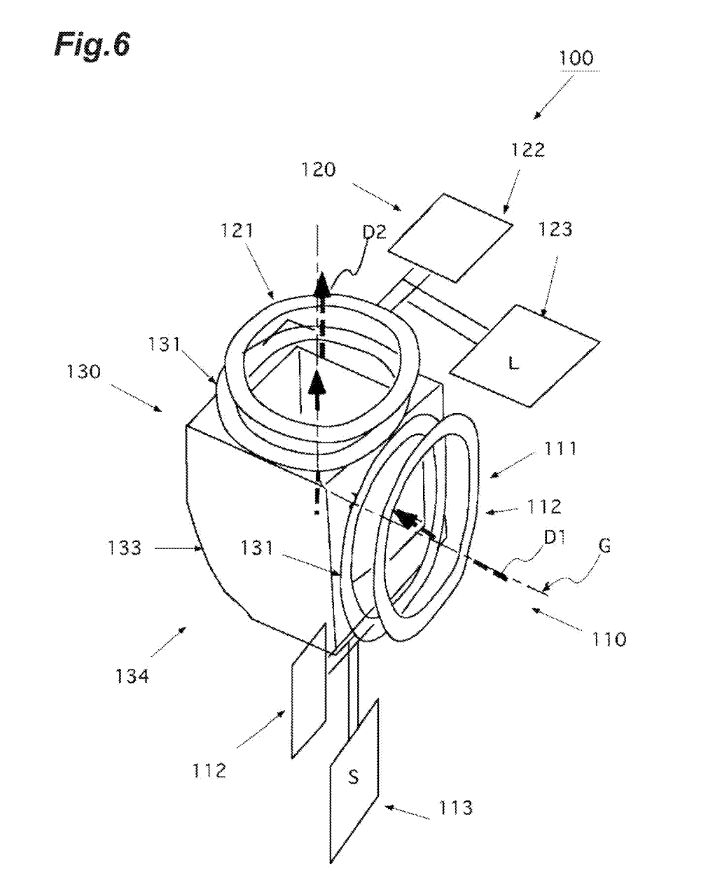

FIG. 6 is a perspective diagram of the wireless power transfer system according to the sixth embodiment of the present disclosure.

The wireless power transfer system 100 according to the sixth embodiment of the present disclosure includes a power supply apparatus 110, a power receiving apparatus 120, and a relay apparatus 130.

Since the configurations of the power supply apparatus 110 and the power receiving apparatus 120 are the same as those of the wireless power transfer system 100 according to the first embodiment, the description will be omitted.

The relay apparatus 130 is an apparatus that relays wireless power transfer from the power supply apparatus 110 to the power receiving apparatus 120.

The relay apparatus 130 includes a relay coil 131 and an iron core 133.

The relay apparatus 130 may include the relay coil 131, an adjustment circuit 132, and the iron core.

Since the relay coil 131 is the same as that of one wireless power transfer system of the wireless power transfer systems according to the second to fourth embodiments of the present disclosure, the description will be omitted.

Since the iron core 133 is the same as that of the wireless power transfer system according to the fifth embodiment of the present disclosure, the description will be omitted.

The relay coil 131 and the iron core 133 are combined to function as a single combination magnetic circuit.

The combination magnetic circuit is configured in such a manner that the relay coil 131 and the iron core 133 are combined such that directions of magnetic fluxes of magnetic fields generated in respective central parts coincide.

Electric power supplied by the wireless power transfer from the power supply primary coil 111 is capable of being supplied to the power supply secondary coil 121 via the combination magnetic circuit.

Hereinafter, a vehicle power supply device according to an embodiment of the present disclosure will be described.

First, a vehicle power supply device according to the first embodiment of the present disclosure will be described based on the drawings.

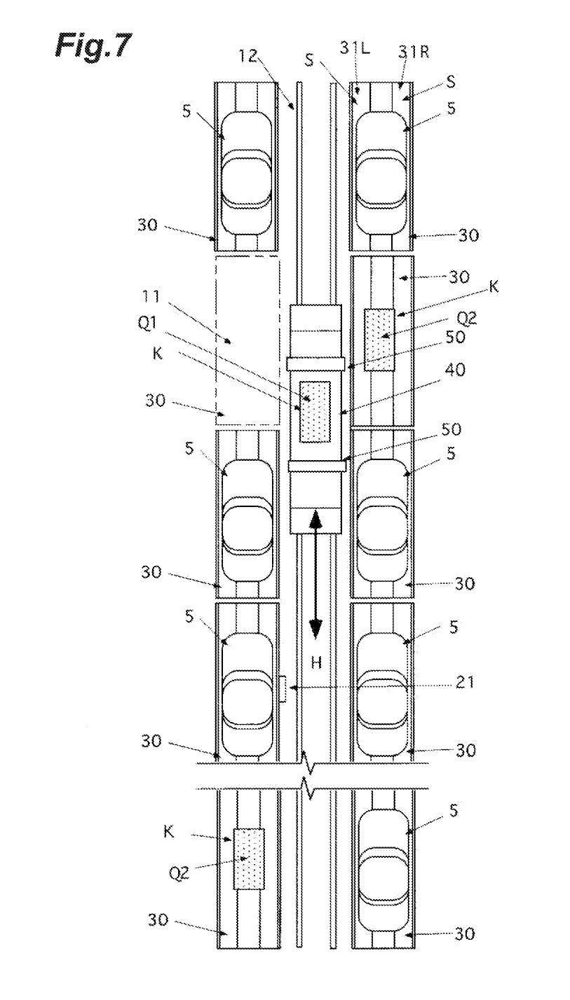

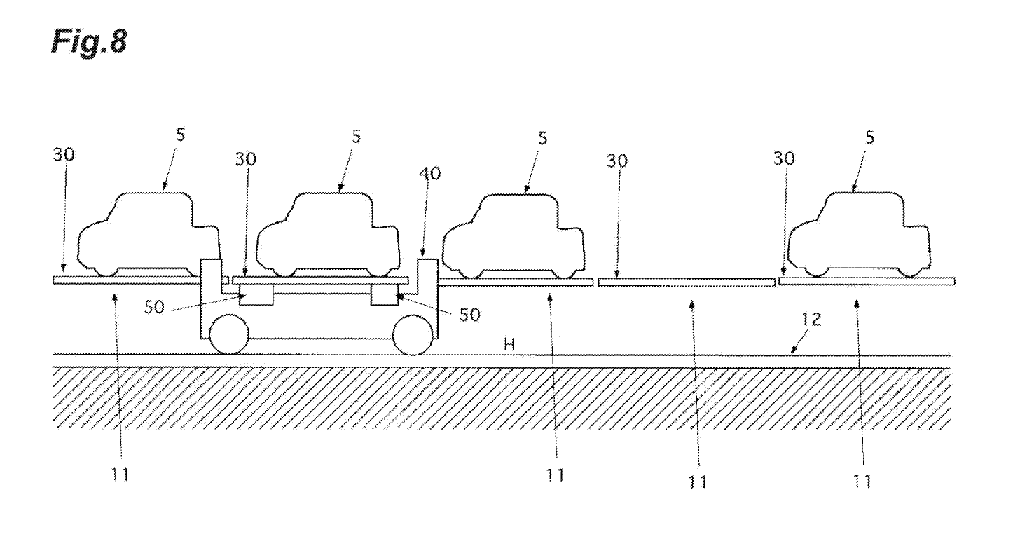

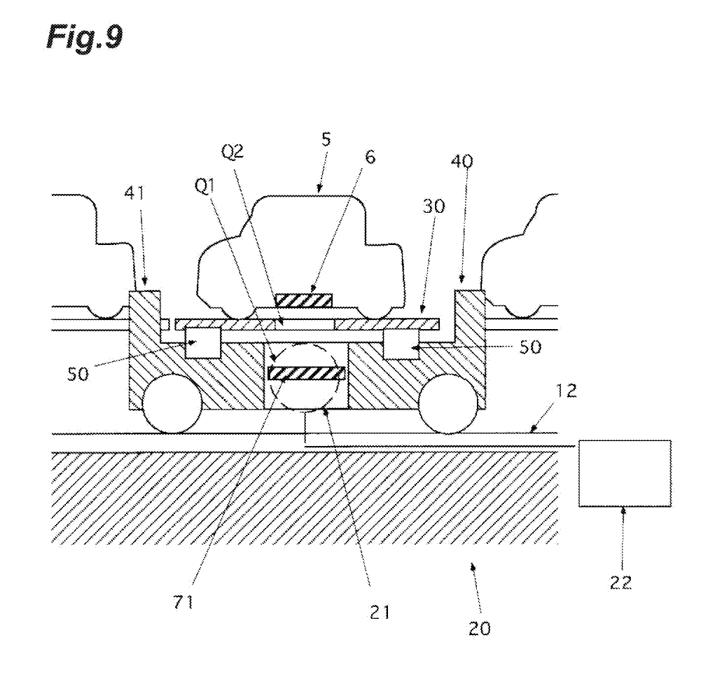

FIG. 7 is a plan view of a parking device to which the vehicle power supply device according to the first embodiment of the present disclosure is applied. FIG. 8 is a side view of the parking device to which the vehicle power supply device according to the first embodiment of the present disclosure is applied. FIG. 9 is a side cross-sectional view of the vehicle power supply device according to the first embodiment of the present disclosure.

The vehicle power supply device according to the first embodiment is configured in such a manner that the present disclosure is applied to a so-called plane reciprocation parking device or an elevator sliding parking device.

The vehicle power supply device according to the first embodiment of the present disclosure is a device that supplies electric power to a vehicle capable of receiving power supply.

The vehicle power supply device according to the first embodiment of the present disclosure includes a main structure (not illustrated), a power supply apparatus 20, a vehicle support structure 30, and a moving carriage 40.

The vehicle power supply device according to the first embodiment of the present disclosure may include the main structure (not illustrated), the power supply apparatus 20, the vehicle support structure 30, the moving carriage 40, and a relay apparatus 70.

The vehicle power supply device according to the first embodiment of the present disclosure may include the main structure (not illustrated), the power supply apparatus 20, the vehicle support structure 30, the moving carriage 40, a transfer apparatus 50, and the relay apparatus 70.

A vehicle 5 is a moving body capable of receiving power supply.

The vehicle 5 may be provided, on a lower surface thereof, with a power supply secondary coil 6 capable of receiving wireless power transfer.

For example, the vehicle 5 is a car having the power supply secondary coil 6 for the wireless power transfer on a bottom part thereof.

To the power supply secondary coil 6, electric power is supplied in a wireless manner from a power supply primary coil 21 placed below the power supply secondary coil 6.

To the power supply secondary coil 6, for example, electric power is supplied in a wireless manner using a magnetic field resonance type from the power supply primary coil 21 placed below the power supply secondary coil 6.

To the power supply secondary coil 6, for example, electric power is supplied in a wireless manner using an electric field resonance type from the power supply primary coil 21 placed below the power supply secondary coil 6.

To the power supply secondary coil 6, for example, electric power is supplied in a wireless manner using an electromagnetic induction type from the power supply primary coil 21 placed below the power supply secondary coil 6.

The main structure (not illustrated) is a principal structure of the vehicle power supply device.

For example, the main structure (not illustrated) is a foundation structure of the vehicle power supply device.

The main structure (not illustrated) is provided with a storage space 11 arranged along a moving path H.

The main structure (not illustrated) may be provided with a plurality of storage spaces 11.

For example, the main structure (not illustrated) includes the plurality of storage spaces 11 and a moving rail 12.

The moving carriage which will be described later runs on the moving rail 12 to move along the moving path H.

The storage space 11 is a space in which a vehicle can be stored.

For example, the storage space 11 is a parking space in which a vehicle can be stored.

For example, the storage space 11 is a space in which the vehicle support structure on which a vehicle has been placed can be stored.

In FIG. 7, it is illustrated that the plurality of storage spaces 11 is arranged in series on the left and right of the moving path H which will be described later.

The power supply apparatus 20 is an apparatus that supplies electric power to the vehicle 5.

The power supply apparatus 20 includes the power supply primary coil 21 and a drive circuit 22.

The power supply primary coil 21 is a power supply primary coil that can supply, in a wireless manner, electric power to the power supply secondary coil 6.

The power supply primary coil 21 is provided at a specific position that is at least one particular position on the moving path H.

For example, the power supply primary coil 21 is provided on a side surface of the specific position that is at least one particular position on the moving path H.

The drive circuit 22 is a circuit that supplies electric power to the power supply primary coil 21 to drive the power supply primary coil 21.

To the drive circuit 22, electric power is supplied from a power source apparatus (not illustrated).

When an electric current flows in the power supply primary coil 21, the electric current can be extracted from the power supply secondary coil.

For example, when an alternating current flows in the power supply primary coil 21, the alternating current can be extracted from the power supply secondary coil 6.

The vehicle support structure 30 is a configuration that can support the vehicle 5.

For example, the vehicle 5 can be placed on the vehicle support structure 30.

For example, the vehicle support structure 30 is provided with a right wheel support structure part 31R and a left wheel support structure part 31L.

The right wheel support structure part 31R is a part that supports a pair of front and rear right wheels of the vehicle 5.

The left wheel support structure part 31L is a part that supports a pair of front and rear left wheels of the vehicle 5.

The right wheel support structure part 31R and the left wheel support structure part 31L integrally support the vehicle.

The vehicle support structure 30 is provided with a void Q2 surrounded by a predetermined contour K between the right wheel support structure part 31R and the left wheel support structure part 31L arranged left and right when viewed from above.

In FIG. 9, it is illustrated that the void Q2 surrounded by the rectangular contour K is provided between the right wheel support structure part 31R and the left wheel support structure part 31L.

The right wheel support structure part 31R and the left wheel support structure part 31L each have a running surface S on which the wheels of the vehicle 5 run.

For example, the vehicle support structure 30 may be a structure having a substantially quadrilateral shape when viewed from above that holds the wheels of the vehicle 5 to support the vehicle, and may be provided with the vehicle support structure void Q2 that is the void having the predetermined contour K and penetrating in a vertical direction.

For example, the vehicle support structure 30 is a so-called pallet, and provided with the void Q2 penetrating a central part of the pallet in the vertical direction when viewed from above.

For example, the pallet rolls the wheels provided at a lower part thereof, and can move between a moving carriage main body 41 which will be described later and the storage space 11.

The moving carriage 40 is a carriage that supports the vehicle 5 and moves along the moving path H.

The moving carriage 40 includes the moving carriage main body 41.

The moving carriage main body 41 is a structure capable of supporting the vehicle support structure 30 that supports the vehicle 5, and moving on the moving path H.

A moving carriage void Q1 is formed in the moving carriage main body.

For example, in the moving carriage main body, the moving carriage void Q1 penetrating in an upward direction and a horizontal direction facing a side surface of the main structure on which the power supply primary coil is provided is formed.

The transfer apparatus 50 is an apparatus that can transfer the vehicle 5 between the moving carriage main body 41 and the storage space 11.

The transfer apparatus 50 may be able to transfer the vehicle support structure 30 that supports the vehicle 5 between the moving carriage main body 41 and the storage space 11.

The relay apparatus 70 is an apparatus that relays the wireless power transfer from the power supply primary coil 21 to the power supply secondary coil 6.

The relay apparatus 70 is provided so as to be surrounded by the contour K of the moving carriage void Q1.

Since the configuration of the relay apparatus 70 is the same as that described in the wireless power transfer system according to the embodiment of the present disclosure, the description will be omitted.

In FIG. 9, it is illustrated that the moving path H extends horizontally, the power supply primary coil 21 is provided on the side surface of the specific position on the moving path H, the moving carriage 40 supports the vehicle support structure 30 that supports the vehicle 5, and the moving carriage 40 stops at the specific position on the moving path H.

In the drawing, a magnetic flux generated in the power supply primary coil 21 is represented by a broken line.

When the moving carriage 40 stops at the specific position on the moving path H, the power supply primary coil 21 and the power supply secondary coil 6 are arranged in this order in series along the bending virtual route G such that the first magnetic flux direction line D1 that is the linear virtual line extending in accordance with the direction of the magnetic flux of the magnetic field generated in the central part of the power supply primary coil 21 and the second magnetic flux direction line D2 that is the linear virtual line extending in accordance with the direction of the magnetic flux of the magnetic field generated in the center of the power supply secondary coil 6 substantially intersect, and the wireless power transfer is performed from the power supply primary coil 21 to the power supply secondary coil 6 incorporated in the vehicle 5 supported by the vehicle support structure 30 supported by the moving carriage 40.

For example, when the moving carriage 40 stops at the specific position on the moving path H, the power supply primary coil 21 and the power supply secondary coil 6 are arranged in this order in series along the 90-degree bending virtual route G such that the first magnetic flux direction line D1 that is the linear virtual line extending in accordance with the direction of the magnetic flux of the magnetic field generated in the central part of the power supply primary coil 21 provided on the side surface of the specific position and the second magnetic flux direction line D2 that is the linear virtual line extending in accordance with the direction of the magnetic flux of the magnetic field generated in the center of the power supply secondary coil 6 are substantially orthogonal to each other, and the wireless power transfer is performed from the power supply primary coil 21 to the power supply secondary coil 6 incorporated in the vehicle 5 supported by the vehicle support structure 30 supported by the moving carriage 40.

When the moving carriage 40 stops at the specific position on the moving path H, the power supply primary coil 21, at least one relay coil 71, and the power supply secondary coil 6 are arranged in this order in series along the bending virtual route G such that the first magnetic flux direction line D1 that is the linear virtual line extending in accordance with the direction of the magnetic flux of the magnetic field generated in the central part of the power supply primary coil 21 and the second magnetic flux direction line D2 that is the linear virtual line extending in accordance with the direction of the magnetic flux of the magnetic field generated in the center of the power supply secondary coil 6 substantially intersect, and electric power supplied by the wireless power transfer from the power supply primary coil 21 is capable of being supplied to the power supply secondary coil 6 via the relay apparatus 70.

For example, when the moving carriage 40 stops at the specific position on the moving path H, the power supply primary coil 21, at least one relay coil 71, and the power supply secondary coil 6 are arranged in this order in series along the 90-degree bending virtual route G such that the first magnetic flux direction line D1 that is the linear virtual line extending in accordance with the direction of the magnetic flux of the magnetic field generated in the central part of the power supply primary coil 21 provided on the side surface of the specific position and the second magnetic flux direction line D2 that is the linear virtual line extending in accordance with the direction of the magnetic flux of the magnetic field generated in the center of the power supply secondary coil 6 are substantially orthogonal to each other, and electric power supplied by the wireless power transfer from the power supply primary coil 21 is capable of being supplied to the power supply secondary coil 6 via the relay apparatus 70.

When the moving carriage 40 stops at the specific position on the moving path H, the generated magnetic flux is relayed to the relay apparatus 70 surrounded by the contour K of the moving carriage void Q1 provided at the moving carriage 40, and the wireless power transfer is capable of being performed to the power supply secondary coil 6 provided at the vehicle 5 supported by the vehicle support structure 30 supported by the moving carriage 40.

When the moving carriage 40 stops at the specific position on the moving path H, the generated magnetic flux passes through the contour K of the vehicle support structure void Q2 provided at the vehicle support structure 30 supported by the moving carriage, and the power supply primary coil 21 is capable of performing the wireless power transfer to the power supply secondary coil 6 provided at the vehicle 5 supported by the vehicle support structure 30 supported by the moving carriage 40.

When the moving carriage 40 stops at the specific position on the moving path H, the generated magnetic flux passes through the contour K of the moving carriage void Q1 provided at the moving carriage 40 and the contour K of the vehicle support structure void Q2 provided at the vehicle support structure 30 supported by the moving carriage, and the power supply primary coil 21 is capable of performing the wireless power transfer to the power supply secondary coil 6 provided at the vehicle 5 supported by the vehicle support structure 30 supported by the moving carriage 40.

Hereinafter, operation of the vehicle power supply device according to the first embodiment of the present disclosure will be described.

Management of the parking device to which the vehicle power supply device is applied includes an entry step, an exit step, and a power supply step.

(Entry Step)

An entry command is received.

The vehicle 5 runs by itself to be placed on the vehicle support structure 30 located in an entry/exit space (not illustrated).

A lifter (not illustrated) moves the vehicle support structure 30 that supports the vehicle 5 from a layer in which the entry/exit space is located to a layer in which the storage space 11 is located.

The transfer apparatus 50 transfers the vehicle support structure 30 that supports the vehicle 5 from the lifter to the moving carriage 40.

The moving carriage 40 supports the vehicle support structure 30 that supports the vehicle 5, and moves on the moving path H.

The moving carriage 40 stops next to one storage space 11.

The transfer apparatus 50 transfers the vehicle support structure 30 that supports the vehicle 5 from the moving carriage 40 to the storage space 11.

(Exit Step)

An exit command is received.

The moving carriage 40 moves along the moving path H to stop next to the storage space 11 in which the vehicle 5 having the exit command is parked.

The transfer apparatus 50 transfers the vehicle support structure 30 that supports the vehicle 5 from the storage space 11 to the moving carriage 40.

The moving carriage 40 moves along the moving path H to a position where the lifter is located.

The transfer apparatus 50 transfers the vehicle support structure 30 that supports the vehicle 5 from the moving carriage 40 to the lifter.

The lifter (not illustrated) moves the vehicle support structure 30 that supports the vehicle 5 from the layer in which the storage space 11 is located to the layer in which the entry/exit space is located.

The vehicle 5 runs by itself to get down from the vehicle support structure 30 located in the entry/exit space (not illustrated).

(Power Supply Step)

A power supply command is received.

The moving carriage 40 moves along the moving path H to stop next to the storage space 11 in which the vehicle 5 having the power supply command is parked.

The transfer apparatus 50 transfers the vehicle support structure 30 that supports the vehicle 5 from the storage space 11 to the moving carriage 40.

The moving carriage 40 moves along the moving path H to the specific position.

The drive circuit 22 drives the power supply primary coil 21, and the wireless power transfer is performed from the power supply primary coil 21 to the power supply secondary coil 6.

The vehicle 5 is charged with the electric power supplied to the power supply secondary coil 6, and outputs a completion signal when the charging is completed.

Upon receiving the completion signal, the moving carriage 40 moves along the moving path H from the specific position, and the moving carriage 40 stops next to one storage space 11.

The transfer apparatus 50 transfers the vehicle support structure 30 that supports the vehicle 5 from the moving carriage 40 to the storage space 11.

Next, a vehicle power supply device according to the second embodiment of the present disclosure will be described based on the drawings.

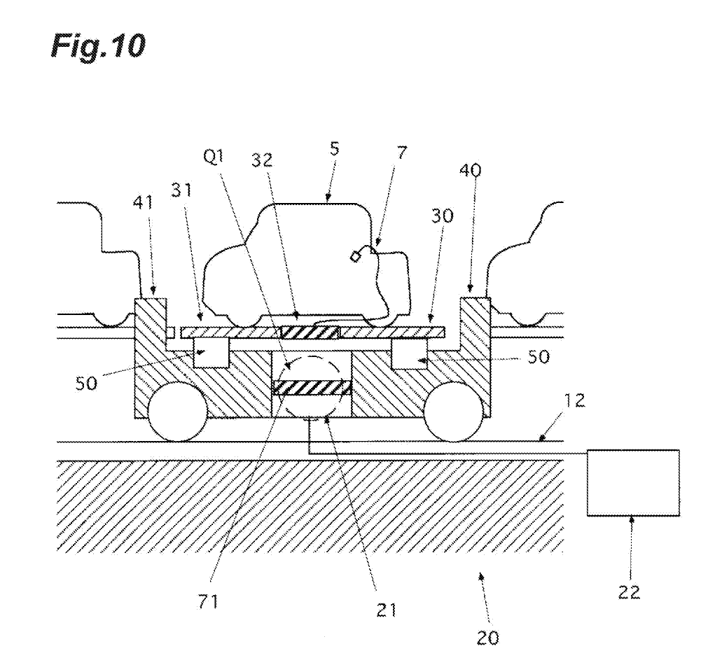

FIG. 10 is a side cross-sectional view of the vehicle power supply device according to the second embodiment of the present disclosure.

The vehicle power supply device according to the second embodiment of the present disclosure is a device that supplies electric power to a vehicle capable of receiving power supply.

The vehicle power supply device according to the second embodiment of the present disclosure includes a main structure (not illustrated), a power supply apparatus 20, a vehicle support structure 30, and a moving carriage 40.

The vehicle power supply device according to the second embodiment of the present disclosure may include the main structure (not illustrated), the power supply apparatus 20, the vehicle support structure 30, the moving carriage 40, and a relay apparatus 130.

The vehicle power supply device according to the second embodiment of the present disclosure may include the main structure (not illustrated), the power supply apparatus 20, the vehicle support structure 30, the moving carriage 40, a transfer apparatus 50, and the relay apparatus 130.

Since the main structure (not illustrated), the power supply apparatus 20, the moving carriage 40, and the transfer apparatus 50 are the same as those of the vehicle power supply device according to the first embodiment, the description will be omitted.

The vehicle support structure 30 has a vehicle support structure main body 31 and a power supply secondary coil 32 provided at the vehicle support structure main body. The vehicle support structure main body 31 is capable of holding wheel of the vehicle 5 to support the vehicle 5.

For example, the vehicle 5 can be placed on the vehicle support structure 30.

For example, the vehicle support structure 30 is provided with a right wheel support structure part 31R and a left wheel support structure part 31L.

The right wheel support structure part 31R is a part that supports a pair of front and rear right wheels of the vehicle 5.

The left wheel support structure part 31L is a part that supports a pair of front and rear left wheels of the vehicle 5.

The right wheel support structure part 31R and the left wheel support structure part 31L integrally support the vehicle.

The vehicle support structure 30 is provided with the power supply secondary coil 32 at a void formed between the right wheel support structure part 31R and the left wheel support structure part 31L arranged left and right when viewed from above.

In FIG. 7, it is illustrated that the power supply secondary coil 32 is provided between the right wheel support structure part 31R and the left wheel support structure part 31L.

The right wheel support structure part 31R and the left wheel support structure part 31L each have a running surface S on which the wheels of the vehicle 5 run.

For example, the vehicle support structure 30 may be a structure having a substantially quadrilateral shape when viewed from above that holds the wheels of the vehicle 5 to support the vehicle, and may be provided with the power supply secondary coil 32.

For example, the vehicle support structure 30 is a so-called pallet, and provided with the power supply secondary coil 32 at a central part of the pallet when viewed from above.

For example, the pallet rolls the wheels provided at a lower part thereof, and can move between a moving carriage main body 41 which will be described later and the storage space 11.

The relay apparatus 130 is provided so as to be surrounded by the contour K of the moving carriage void Q1.

Since the configuration of the relay apparatus 130 is the same as that described in the wireless power transfer system according to the embodiment of the present disclosure, the description will be omitted.

When the moving carriage 40 stops at the specific position on the moving path H, the magnetic flux passes through the relay apparatus 130 surrounded by the contour K of the moving carriage void Q1 provided at the moving carriage 40, and the power supply primary coil 21 is capable of performing the wireless power transfer to the power supply secondary coil 32 provided at the vehicle support structure 30 supported by the moving carriage 40.

Electric power supplied by the wireless power transfer to the power supply secondary coil 32 is supplied to the vehicle 5 via a charging cable 7.

Since operation of the vehicle power supply device according to the second embodiment of the present disclosure is substantially the same as the operation of the vehicle power supply device according to the first embodiment except for the above-mentioned route for supplying electric power from the power supply primary coil to the vehicle, the description will be omitted.

Next, a vehicle power supply device according to the third embodiment of the present disclosure will be described based on the drawings.

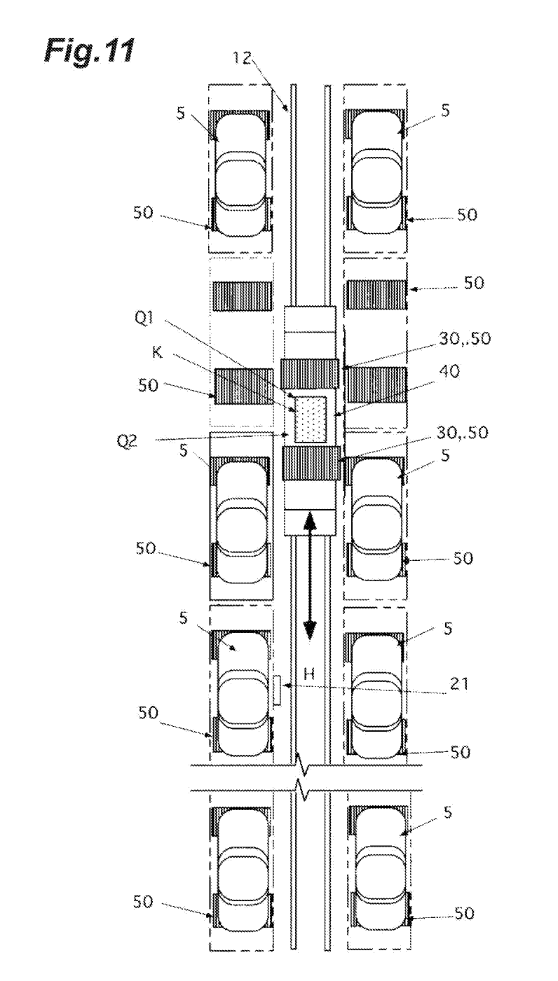

FIG. 11 is a plan view of the vehicle power supply device according to the third embodiment of the present disclosure.

The vehicle power supply device according to the third embodiment of the present disclosure is a device that supplies electric power to a vehicle capable of receiving power supply.

The vehicle power supply device according to the third embodiment of the present disclosure includes a main structure (not illustrated), a power supply apparatus 20, a vehicle support structure 30, and a moving carriage 40.

The vehicle power supply device according to the third embodiment of the present disclosure may include the main structure (not illustrated), the power supply apparatus 20, the vehicle support structure 30, the moving carriage 40, and a relay apparatus 130.

The vehicle power supply device according to the third embodiment of the present disclosure may include the main structure (not illustrated), the power supply apparatus 20, the vehicle support structure 30, the moving carriage 40, a transfer apparatus 50, and the relay apparatus 130.

Since the configurations of a vehicle 5, the main structure (not illustrated), the power supply apparatus 20, the moving carriage 40, and the relay apparatus 130 are the same as those of the vehicle power supply devices according to the first to second embodiments, the description will be omitted.

The vehicle support structure 30 is a configuration that can support the vehicle 5.

The vehicle support structure 30 includes a pair of conveyers on which the vehicle 5 can be placed.

For example, the vehicle support structure 30 includes a pair of front and rear conveyers.

For example, the vehicle support structure 30 includes a pair of left and right conveyers.

Wheels of the vehicle are placed on the conveyer, so that the conveyer supports the vehicle.

The vehicle support structure 30 is provided, at a position sandwiched between the pair of conveyers, with a vehicle support structure void that is a void having a predetermined contour K and penetrating in a vertical direction.

In FIG. 11, the vehicle support structure including the pair of front and rear conveyers is illustrated.

The transfer apparatus 50 is an apparatus that can transfer the vehicle between the moving carriage main body and the storage space.

The transfer apparatus 50 includes a pair of conveyers.

For example, the transfer apparatus 50 includes a pair of front and rear conveyers.

For example, the transfer apparatus 50 includes a pair of left and right conveyers.

The conveyer of the vehicle support structure 30 and the conveyer of the transfer apparatus 50 operate in cooperation with each other to transfer the vehicle between the conveyer of the vehicle support structure 30 and the conveyer of the transfer apparatus 50.

Since operation of the vehicle power supply device according to the third embodiment is substantially the same as the operation of the vehicle power supply devices according to the first to the second embodiments except for the above-mentioned configuration of the vehicle support structure, the description will be omitted.

Next, a vehicle power supply device according to the fourth embodiment of the present disclosure will be described based on the drawings.

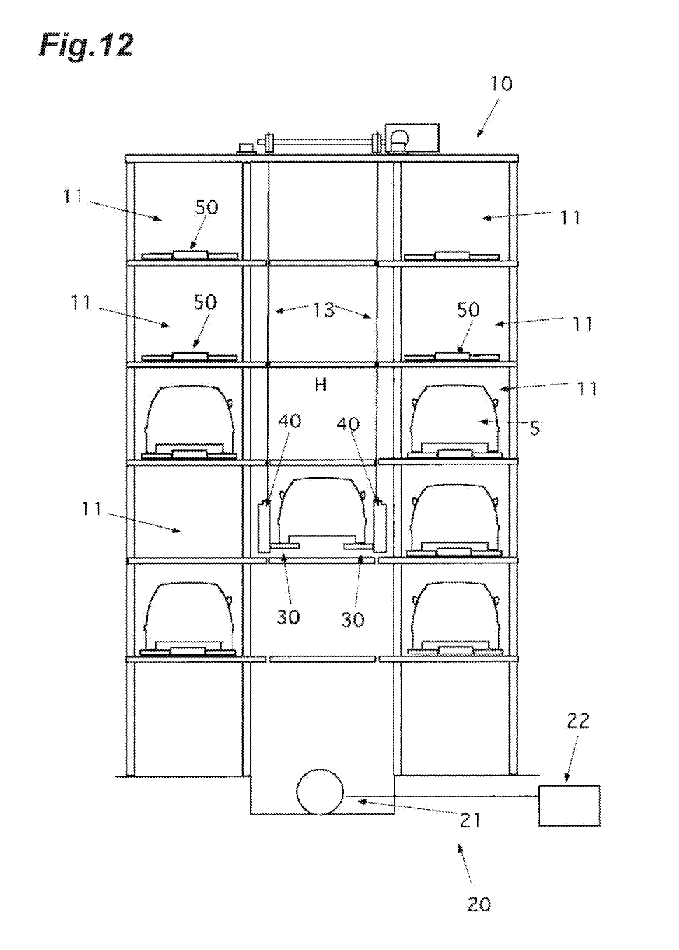

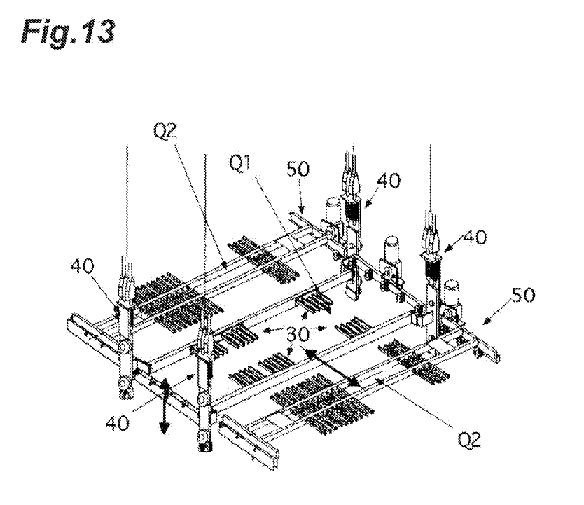

FIG. 12 is a front view of the vehicle power supply device according to the fourth embodiment of the present disclosure. FIG. 13 is a perspective view of the vehicle power supply device according to the fourth embodiment of the present disclosure.

The vehicle power supply device according to the fourth embodiment of the present disclosure is a device that supplies electric power to a vehicle capable of receiving power supply.

The vehicle power supply device according to the fourth embodiment of the present disclosure includes a main structure 10, a power supply apparatus 20, a vehicle support structure 30, and a moving carriage 40.

The vehicle power supply device according to the fourth embodiment of the present disclosure may include the main structure 10, the power supply apparatus 20, the vehicle support structure 30, the moving carriage 40, and a relay apparatus 130.

The vehicle power supply device according to the fourth embodiment of the present disclosure may include the main structure 10, the power supply apparatus 20, the vehicle support structure 30, the moving carriage 40, a transfer apparatus 50, and the relay apparatus 130.

The vehicle power supply device according to the fourth embodiment of the present disclosure may include the main structure 10, the power supply apparatus 20, the vehicle support structure 30, the moving carriage 40, a transfer apparatus 50, and the relay apparatus 130.

Since a vehicle is the same as those of the vehicle power supply devices according to the first to second embodiments, the description will be omitted.

The main structure 10 is a principal structure of the vehicle power supply device.

For example, the main structure 10 is a foundation structure of the vehicle power supply device.

The main structure 10 is provided with a storage space 11 arranged along a moving path H extending in a vertical direction.

The main structure 10 may be provided with a plurality of storage spaces 11.

For example, the main structure 10 includes the plurality of storage spaces 11.

The moving carriage which will be described later moves along the moving path H in the vertical direction.

The storage space 11 is a space in which a vehicle can be stored.

For example, the storage space 11 is a parking space in which a vehicle can be stored.

For example, the storage space 11 is a space in which the vehicle support structure on which a vehicle has been placed can be stored.

In FIG. 12, it is illustrated that the plurality of storage spaces 11 is arranged in series in the vertical direction on the left and right of the moving path H which will be described later.

The power supply apparatus 20 is an apparatus that supplies electric power to the vehicle 5.

The power supply apparatus 20 includes the power supply primary coil 21 and a drive circuit 22.

The power supply primary coil 21 is a power supply primary coil that can supply, in a wireless manner, electric power to the power supply secondary coil.

The power supply primary coil 21 is provided at a specific position that is at least one particular position on the moving path H.

For example, the power supply primary coil 21 is provided on a side surface of the lowermost part of the moving path H.

For example, the power supply primary coil 21 is provided on a wall in the middle of the moving path H.

Since the drive circuit 22 is the same as that of the vehicle power supply device according to the first embodiment, the description will be omitted.

The vehicle support structure 30 is a configuration that can support the vehicle 5.

For example, the vehicle 5 can be placed on the vehicle support structure 30.

The vehicle support structure 30 includes a pair of comb-shaped support members.

For example, the vehicle support structure 30 includes a pair of left and right comb-shaped support members.

The pair of left and right comb-shaped support members has a plurality of rod-shaped members arranged in a front-rear direction so as to hold wheels of the vehicle and support the vehicle.

In FIG. 13, it is illustrated that the vehicle support structure 30 is configured such that each of the pair of left and right comb-shaped support members has the plurality of rod-shaped members on which front wheels and rear wheels of the vehicle are placed, is supported by the moving carriage 40, and is capable of moving on the moving path H in the vertical direction.

The vehicle support structure 30 is provided, at a position sandwiched between the pair of left and right comb-shaped support members, with a vehicle support structure void that is a void having a predetermined contour K when viewed from above and penetrating in the vertical direction.

The moving carriage 40 is a carriage that supports the vehicle 5 and moves along the moving path H.

The moving carriage 40 includes a moving carriage main body (not illustrated).

The moving carriage main body 41 is a structure capable of supporting the vehicle support structure 30 that supports the vehicle 5, and moving on the moving path H in the vertical direction.

Since other configurations of the moving carriage are the same as those of the vehicle power supply devices according to the first to second embodiments, the description will be omitted.

The transfer apparatus 50 is an apparatus that can transfer the vehicle 5 between the moving carriage main body 41 and the storage space 11.

The transfer apparatus 50 can move the vehicle 5 between the moving carriage main body 41 that has stopped on the moving path H and the storage space 11.

The transfer apparatus 50 has a plurality of rod-shaped members that can support the wheels of the vehicle 5.

Since operation of the vehicle power supply device according to the fourth embodiment is the same as the operation of the vehicle power supply device according to the first embodiment except for the above-mentioned moving path that extends in the vertical direction and the configuration of the vehicle support structure, the description will be omitted.

Next, a vehicle power supply device according to the fifth embodiment of the present disclosure will be described based on the drawings.

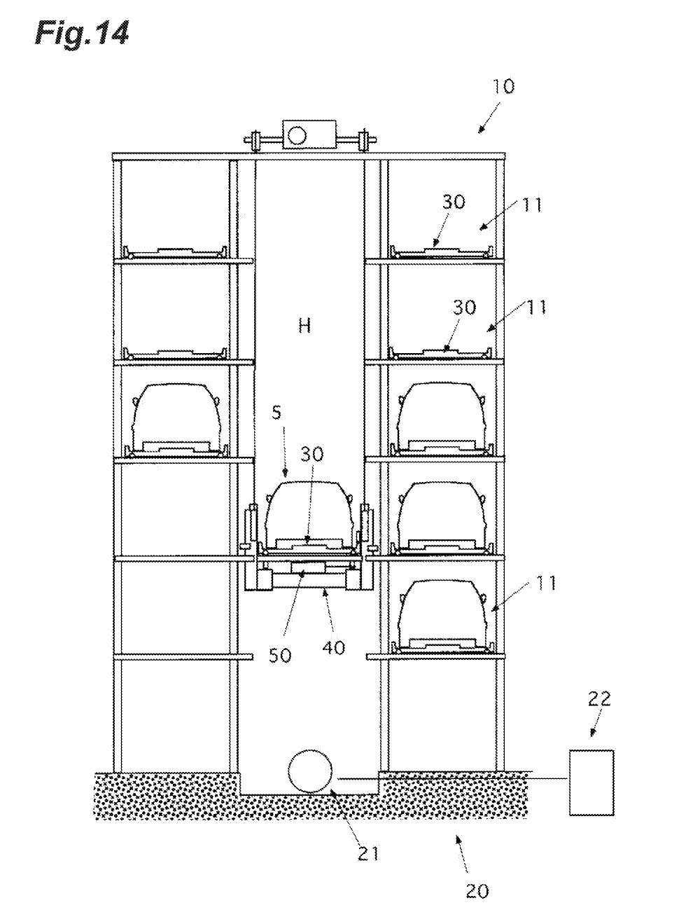

FIG. 14 is a front view of the vehicle power supply device according to the fifth embodiment of the present disclosure.

The vehicle power supply device according to the fifth embodiment of the present disclosure is a device that supplies electric power to a vehicle capable of receiving power supply.

The vehicle power supply device according to the fifth embodiment of the present disclosure includes a main structure 10, a power supply apparatus 20, a vehicle support structure 30, and a moving carriage 40.

The vehicle power supply device according to the fifth embodiment of the present disclosure may include the main structure 10, the power supply apparatus 20, the vehicle support structure 30, the moving carriage 40, and a relay apparatus 130.

The vehicle power supply device according to the fifth embodiment of the present disclosure may include the main structure 10, the power supply apparatus 20, the vehicle support structure 30, the moving carriage 40, a transfer apparatus 50, and the relay apparatus 130.

Since a vehicle, the vehicle support structure 30, the moving carriage 40, the transfer apparatus 50, and the relay apparatus 130 are the same as those of the vehicle power supply devices according to the first to fourth embodiments, the description will be omitted.

The main structure 10 is a principal structure of the vehicle power supply device.

For example, the main structure 10 is a foundation structure of the vehicle power supply device.

The main structure 10 is provided with a storage space 11 arranged along a moving path H extending in a vertical direction.

The main structure 10 may be provided with a plurality of storage spaces 11.

For example, the main structure 10 includes the plurality of storage spaces 11.

The moving carriage which will be described later moves along the moving path H in the vertical direction.

The storage space 11 is a space in which a vehicle can be stored.

For example, the storage space 11 is a parking space in which a vehicle can be stored.

For example, the storage space 11 is a space in which the vehicle support structure on which a vehicle has been placed can be stored.

In FIG. 14, it is illustrated that the plurality of storage spaces 11 is arranged in series in the vertical direction on the left and right of the moving path H which will be described later.

The power supply apparatus 20 is an apparatus that supplies electric power to the vehicle 5.

The power supply apparatus 20 includes the power supply primary coil 21 and a drive circuit 22.

The power supply primary coil 21 is a power supply primary coil that can supply, in a wireless manner, electric power to the power supply secondary coil.

The power supply primary coil 21 is provided on a side surface of a specific position that is at least one particular position on the moving path H.

For example, the power supply primary coil 21 is provided on a side surface of the lowermost part of the moving path H.

For example, the power supply primary coil 21 is provided on a wall in the middle of the moving path H.

Since the drive circuit 22 is the same as that of the vehicle power supply device according to the first embodiment, the description will be omitted.

Since operation of the vehicle power supply device according to the fifth embodiment is substantially the same as the operation of the vehicle power supply device according to the first embodiment except for the moving path that extends in the vertical direction, the description will be omitted.

The wireless power transfer system according to the embodiment of the present disclosure has the following effects owing to its configuration.

As the power supply primary coil 111 driven by the drive circuit 113 and the power supply secondary coil 121 that supplies electric power to the load 123 are arranged in this order in series along the bending virtual route G such that the directions of the magnetic fluxes of the magnetic fields generated in the respective central parts substantially intersect, when electric power supplied by the wireless power transfer from the power supply primary coil 111 is supplied to the power supply secondary coil 121, the wireless power transfer can be performed from the power supply primary coil 111 to the power supply secondary coil 121 that is in a relatively inclined posture.

As the power supply primary coil 111 driven by the drive circuit 113, the electrically independent relay coil 131, and the power supply secondary coil 121 that supplies electric power to the load 123 are arranged in this order in series along the bending virtual route such that the directions of the magnetic fluxes of the magnetic fields generated in the respective central parts intersect, when electric power supplied by the wireless power transfer from the power supply primary coil 111 is supplied to the power supply secondary coil 121 via the relay coil 131, the wireless power transfer can be performed from the power supply primary coil 111 to the power supply secondary coil 121 that is physically distant from the power supply primary coil 111 and in the relatively inclined posture.

The slope of the linear virtual line extending in accordance with the direction of the magnetic flux of the magnetic field generated in the central part of the relay coil 131 is between the slope of the first magnetic flux direction line D1 and the slope of the second magnetic flux direction line D2. Electric power supplied by the wireless power transfer from the power supply primary coil 111 is supplied to the power supply secondary coil 121 via the relay coil 131. Therefore, the wireless power transfer can be efficiently performed from the power supply primary coil 111 to the power supply secondary coil 121 that is physically distant from the power supply primary coil 111 and in the relatively inclined posture.

The first coil circuit 1311 and the second coil circuit 1312 serving as the integrated coil structure are used, the magnetic flux direction in the central part of the first coil circuit 1311 is made to coincide with the first magnetic flux direction line D1, and the magnetic flux direction in the central part of the second coil circuit 1312 is made to coincide with the second magnetic flux direction line D2. When the wireless power transfer is performed from the power supply primary coil 111 to the first coil circuit 1311, the wireless power transfer is simultaneously performed from the second coil circuit 1312 to the power supply secondary coil 121. Therefore, the wireless power transfer can be efficiently performed from the power supply primary coil 111 to the power supply secondary coil 121 that is physically distant from the power supply primary coil 111 and in the relatively inclined posture.

The first coil circuit 1311 and the second coil circuit 1312 serving as the integrated coil structure including the unicursal electric circuit are used, the magnetic flux direction in the central part of the first coil circuit 1311 is made to coincide with the first magnetic flux direction line D1, and the magnetic flux direction in the central part of the second coil circuit 1312 is made to coincide with the second magnetic flux direction line D2. When the wireless power transfer is performed from the power supply primary coil 111 to the first coil circuit 1311, the wireless power transfer is simultaneously performed from the second coil circuit 1312 to the power supply secondary coil 121. Therefore, the wireless power transfer can be efficiently performed from the power supply primary coil 111 to the power supply secondary coil 121 that is physically distant from the power supply primary coil 111 and in the relatively inclined posture.

The first relay coil 131a, the second relay coil 131b, and the capacitor 135 are used, the magnetic flux direction in the central part of the first relay coil 131a is made to coincide with the first magnetic flux direction line D1, and the magnetic flux direction in the central part of the second relay coil 131b is made to coincide with the second magnetic flux direction line D2. When the wireless power transfer is performed from the power supply primary coil 111 to the first relay coil 131a to charge the capacitor 135, the wireless power transfer is simultaneously performed from the second relay coil 131b to the power supply secondary coil 121. Therefore, the wireless power transfer can be efficiently performed from the power supply primary coil 111 to the power supply secondary coil 121 that is physically distant from the power supply primary coil 111 and in the relatively inclined posture.

The wireless power transfer is performed from the power supply primary coil 111 to the power supply secondary coil 121 via the iron core that is the lump surrounded by the first end surface that is the end surface orthogonal to the first magnetic flux direction line D1, the second end surface that is the end surface orthogonal to the second magnetic flux direction line D2, and the side surface. Therefore, the wireless power transfer can be efficiently performed from the power supply primary coil 111 to the power supply secondary coil 121 that is physically distant from the power supply primary coil 111 and in the relatively inclined posture.

The vehicle power supply device according to the embodiment of the present disclosure has the following effects owing to its configuration.

The power supply primary coil 21 driven by the drive circuit is provided on the side surface at the specific position on the moving path H. When the moving carriage 40 that supports the vehicle support structure 30 that supports the vehicle 5 is stopped at the specific position, electric power supplied by the wireless power transfer from the power supply primary coil 21 is supplied to the vehicle 5 supported by the vehicle support structure 30 supported by the moving carriage 40. Therefore, electric power can be supplied to the vehicle 5 supported by the vehicle support structure 30 supported by the moving carriage 40 that moves along the moving path.

The power supply primary coil 21 driven by the drive circuit 22 is provided on the side surface at the specific position on the moving path H. When the moving carriage 40 that supports the vehicle support structure 30 that supports the vehicle 5 is stopped at the specific position, electric power supplied by the wireless power transfer from the power supply primary coil 21 is supplied to the power supply secondary coil 32 provided at the vehicle support structure 30 supported by the moving carriage 40, and the supplied electric power is supplied to the vehicle 5 supported by the vehicle support structure 30. Therefore, electric power can be supplied to the vehicle supported by the vehicle support structure supported by the moving carriage that moves along the moving path.

The power supply primary coil 21 driven by the drive circuit 22 is provided on the side surface at the specific position on the moving path H, and the electrically independent relay coil 131 is provided at the moving carriage. When the moving carriage 40 that supports the vehicle support structure 30 that supports the vehicle 5 is stopped at the specific position, electric power supplied by the wireless power transfer from the power supply primary coil 21 is supplied by the wireless power transfer via the relay coil 131, and supplied to the vehicle 5 supported by the moving carriage 40. Therefore, electric power can be supplied to the vehicle 5 supported by the vehicle support structure 30 supported by the moving carriage 40 that moves along the moving path H.

The power supply primary coil 21 driven by the drive circuit 22 is provided on the side surface at the specific position on the moving path H, and the iron core that functions as the magnetic circuit is provided at the moving carriage. When the moving carriage 40 that supports the vehicle support structure 30 that supports the vehicle 5 is stopped at the specific position, electric power supplied by the wireless power transfer from the power supply primary coil 21 is supplied by the wireless power transfer via the iron core, and supplied to the vehicle 5 supported by the moving carriage 40. Therefore, electric power can be supplied to the vehicle 5 supported by the vehicle support structure 30 supported by the moving carriage 40 that moves along the moving path.

The present disclosure is not limited to the above-mentioned embodiments, and can be variously changed in a range not deviating from the gist of the disclosure.

Although an exemplary case where the vehicle power supply device includes the relay apparatus has been described, the present disclosure is not limited to this exemplary case. The vehicle power supply device may not include the relay apparatus.

A plate made of a material that does not affect the magnetic field may cover the void.

Although an exemplary case where the present disclosure is applied to the parking device has been described, the present disclosure is not limited to this exemplary case. For example, such a case may be employed that the transfer apparatus or the storage space is not included.

Although an exemplary case where a moving mechanism of the parking device is configured to be an elevator parking device has been described, the present disclosure is not limited to this exemplary case. For example, a circulation mechanism may be employed, such as a box circulation parking device, a horizontal circulation parking device, a merry-go-round parking device, an elevator sliding parking device, a plane reciprocating parking device, a transporting storage parking device, and a two-stage or multiple-stage parking device.

### INDUSTRIAL APPLICABILITY

According to some aspects of the present disclosure, easily available power supply can be performed using a simple structure.

### REFERENCE SIGNS LIST

D1 first magnetic flux direction line
D2 second magnetic flux direction line
H moving path
Q1 moving carriage void
Q2 vehicle support structure void
K contour
5 vehicle
6 power supply secondary coil
7 charging cable
10 main structure
11 storage space
12 moving rail
20 power supply apparatus
21 power supply primary coil
22 drive circuit
30 vehicle support structure
31 vehicle support structure main body
31L left wheel support structure part
31R right wheel support structure part
32 power supply secondary coil
40 moving carriage
41 moving carriage main body
50 transfer apparatus
70 relay apparatus
71 relay coil
100 wireless power transfer system
110 power supply apparatus
111 power supply primary coil
112 adjustment circuit
113 drive circuit
120 power receiving apparatus
121 power supply secondary coil
122 adjustment circuit
123 load
130 relay apparatus
131 relay coil
1311 first coil circuit
1312 second coil circuit
131a first relay coil
131b second relay coil
132 adjustment circuit
132a first adjustment circuit
132b second adjustment circuit
133 iron core
134 combination magnetic circuit
135 capacitor

1. A wireless power transfer system comprising:
a power receiving apparatus having a power supply secondary coil that is a coil circuit capable of performing wireless power transfer, the power receiving apparatus being capable of supplying electric power to a load; and
a power supply apparatus having a power supply primary coil that is a coil circuit capable of performing the wireless power transfer, and a drive circuit that drives the power supply primary coil, wherein
the power supply primary coil and the power supply secondary coil are arranged such that a first magnetic flux direction line that is a linear virtual line extending in accordance with a direction of a magnetic flux of a magnetic field generated in a central part of the power supply primary coil and a second magnetic flux direction line that is a linear virtual line extending in accordance with a direction of a magnetic flux of a magnetic field generated in a center of the power supply secondary coil substantially intersect, and electric power supplied by the wireless power transfer from the power supply primary coil is capable of being supplied to the power supply secondary coil.

2. The wireless power transfer system according to claim 1, comprising a relay apparatus having at least one relay coil that is a coil circuit, wherein
the power supply primary coil, at least one of the relay coil, and the power supply secondary coil are arranged such that the first magnetic flux direction line that is the linear virtual line extending in accordance with the direction of the magnetic flux of the magnetic field generated in the central part of the power supply primary coil and the second magnetic flux direction line that is the linear virtual line extending in accordance with the direction of the magnetic flux of the magnetic field generated in the center of the power supply secondary coil substantially intersect, and electric power supplied by the wireless power transfer from the power supply primary coil is capable of being supplied to the power supply secondary coil via the relay apparatus.

3. The wireless power transfer system according to claim 2, wherein
a slope of a linear virtual line extending in accordance with a direction of a magnetic flux of a magnetic field generated in a central part of the relay coil is between a slope of the first magnetic flux direction line and a slope of the second magnetic flux direction line, and
electric power supplied by the wireless power transfer from the power supply primary coil is capable of being supplied to the power supply secondary coil via the relay coil.

4. The wireless power transfer system according to claim 2, wherein
the relay coil has a first coil circuit and a second coil circuit serving as an integrated coil structure,
a linear virtual line extending in accordance with a direction of a magnetic flux of a magnetic field generated in a central part of the first coil circuit coincides with the first magnetic flux direction line,
a linear virtual line extending in accordance with a direction of a magnetic flux of a magnetic field generated in a central part of the second coil circuit coincides with the second magnetic flux direction line, and
when the wireless power transfer is performed from the power supply primary coil to the first coil circuit of the relay coil, the wireless power transfer is simultaneously capable of being performed from the second coil circuit of the relay coil to the power supply secondary coil.

5. The wireless power transfer system according to claim 2, wherein
a relay apparatus has a first relay circuit and a second relay circuit that are the two relay circuits, and has a capacitor,
the first relay circuit has a first relay coil,
the second relay circuit has a second relay coil,
a linear virtual line extending in accordance with a direction of a magnetic flux of a magnetic field generated in a central part of the first relay coil of the first relay circuit coincides with the first magnetic flux direction line,
a linear virtual line extending in accordance with a direction of a magnetic flux of a magnetic field generated in a central part of the second relay coil of the second relay circuit coincides with the second magnetic flux direction line, and
when electric power supplied by the wireless power transfer from the power supply primary coil to the first relay coil is stored in or discharged into the capacitor, electric power is simultaneously supplied by the wireless power transfer from the second relay coil to the power supply secondary coil.

6. The wireless power transfer system according to claim 1, comprising a relay apparatus having an iron core that functions as a magnetic circuit, wherein
the iron core is a lump surrounded by a first end surface that is an end surface orthogonal to the first magnetic flux direction line, a second end surface that is an end surface orthogonal to the second magnetic flux direction line, and a side surface, and
electric power supplied by the wireless power transfer from the power supply primary coil is capable of being supplied to the power supply secondary coil via the iron core.

7. The wireless power transfer system according to claim 2, comprising a relay apparatus having an iron core that functions as a magnetic circuit, wherein
the iron core is a lump surrounded by a first end surface that is an end surface orthogonal to the first magnetic flux direction line, a second end surface that is an end surface orthogonal to the second magnetic flux direction line, and a side surface, and
electric power supplied by the wireless power transfer from the power supply primary coil is capable of being supplied to the power supply secondary coil via the iron core.

8. A vehicle power supply device that supplies electric power to a vehicle, the vehicle incorporating a power supply secondary coil, the vehicle power supply device comprising:
a main structure provided with a storage space arranged along a moving path;
a power supply apparatus provided at a specific position that is at least one particular position on the moving path, the power supply apparatus having a power supply primary coil capable of performing wireless power transfer and a drive circuit that drives the power supply primary coil;
a vehicle support structure that is a structure capable of supporting the vehicle;
a moving carriage having a moving carriage main body and the power supply primary coil incorporated in the moving carriage main body, the moving carriage main body being capable of supporting the vehicle support structure that supports the vehicle and moving on the moving path; and
a transfer apparatus capable of transferring the vehicle between the moving carriage main body and the storage space, wherein
when the moving carriage stops at the specific position on the moving path,
the power supply primary coil and the power supply secondary coil are arranged such that a first magnetic flux direction line that is a linear virtual line extending in accordance with a direction of a magnetic flux of a magnetic field generated in a central part of the power supply primary coil and a second magnetic flux direction line that is a linear virtual line extending in accordance with a direction of a magnetic flux of a magnetic field generated in a center of the power supply secondary coil substantially intersect, and the wireless power transfer is performed from the power supply primary coil to the power supply secondary coil incorporated in the vehicle supported by the vehicle support structure supported by the moving carriage.

9. A vehicle power supply device that supplies electric power to a vehicle, the vehicle power supply device comprising:
a main structure provided with a storage space arranged along a moving path;
a power supply apparatus provided at a specific position that is at least one particular position on the moving path, the power supply apparatus having a power supply primary coil capable of performing wireless power transfer and a drive circuit that drives the power supply primary coil;
a vehicle support structure having a vehicle support structure main body and a power supply secondary coil, the vehicle support structure main body being capable of holding a wheel of the vehicle to support the vehicle, the power supply secondary coil being provided at the vehicle support structure main body and capable of receiving the wireless power transfer;
a moving carriage having a moving carriage main body and the power supply primary coil incorporated in the moving carriage main body, the moving carriage main body being capable of supporting the vehicle support structure that supports the vehicle and moving on the moving path; and
a transfer apparatus capable of transferring the vehicle between the moving carriage main body and the storage space, wherein
when the moving carriage stops at the specific position on the moving path,
the power supply primary coil and the power supply secondary coil are arranged such that a first magnetic flux direction line that is a linear virtual line extending in accordance with a direction of a magnetic flux of a magnetic field generated in a central part of the power supply primary coil and a second magnetic flux direction line that is a linear virtual line extending in accordance with a direction of a magnetic flux of a magnetic field generated in a center of the power supply secondary coil substantially intersect, the wireless power transfer is performed from the power supply primary coil to the power supply secondary coil of the vehicle support structure supported by the moving carriage, and electric power supplied by the wireless power transfer to the power supply secondary coil is supplied to the vehicle supported by the vehicle support structure.

10. The vehicle power supply device according to claim 8, comprising a relay apparatus incorporated in the moving carriage main body and having a relay coil that is a coil circuit, wherein
when the moving carriage stops at the specific position on the moving path,
the power supply primary coil, at least one of the relay coil, and the power supply secondary coil are arranged such that the first magnetic flux direction line that is the linear virtual line extending in accordance with the direction of the magnetic flux of the magnetic field generated in the central part of the power supply primary coil and the second magnetic flux direction line that is the linear virtual line extending in accordance with the direction of the magnetic flux of the magnetic field generated in the center of the power supply secondary coil substantially intersect, and electric power supplied by the wireless power transfer from the power supply primary coil is capable of being supplied to the power supply secondary coil via the relay apparatus.

11. The vehicle power supply device according to claim 9, comprising a relay apparatus incorporated in the moving carriage main body and having a relay coil that is a coil circuit, wherein
when the moving carriage stops at the specific position on the moving path,
the power supply primary coil, at least one of the relay coil, and the power supply secondary coil are arranged such that the first magnetic flux direction line that is the linear virtual line extending in accordance with the direction of the magnetic flux of the magnetic field generated in the central part of the power supply primary coil and the second magnetic flux direction line that is the linear virtual line extending in accordance with the direction of the magnetic flux of the magnetic field generated in the center of the power supply secondary coil substantially intersect, and electric power supplied by the wireless power transfer from the power supply primary coil is capable of being supplied to the power supply secondary coil via the relay apparatus.

12. The vehicle power supply device according to claim 8, comprising a relay apparatus incorporated in the moving carriage main body and having an iron core that functions as a magnetic circuit, wherein
when the moving carriage stops at the specific position on the moving path,
the iron core is a lump surrounded by a first end surface that is an end surface orthogonal to the first magnetic flux direction line, a second end surface that is an end surface orthogonal to the second magnetic flux direction line, and a side surface, and
the power supply primary coil, at least one of the iron core, and the power supply secondary coil are arranged such that the first magnetic flux direction line that is the linear virtual line extending in accordance with the direction of the magnetic flux of the magnetic field generated in the central part of the power supply primary coil and the second magnetic flux direction line that is the linear virtual line extending in accordance with the direction of the magnetic flux of the magnetic field generated in the center of the power supply secondary coil substantially intersect, and electric power supplied by the wireless power transfer from the power supply primary coil is capable of being supplied to the power supply secondary coil via the relay apparatus.

13. The vehicle power supply device according to claim 9, comprising a relay apparatus incorporated in the moving carriage main body and having an iron core that functions as a magnetic circuit, wherein
when the moving carriage stops at the specific position on the moving path,
the iron core is a lump surrounded by a first end surface that is an end surface orthogonal to the first magnetic flux direction line, a second end surface that is an end surface orthogonal to the second magnetic flux direction line, and a side surface, and
the power supply primary coil, at least one of the iron core, and the power supply secondary coil are arranged such that the first magnetic flux direction line that is the linear virtual line extending in accordance with the direction of the magnetic flux of the magnetic field generated in the central part of the power supply primary coil and the second magnetic flux direction line that is the linear virtual line extending in accordance with the direction of the magnetic flux of the magnetic field generated in the center of the power supply secondary coil substantially intersect, and electric power supplied by the wireless power transfer from the power supply primary coil is capable of being supplied to the power supply secondary coil via the relay apparatus.
